(19) United States
(12) Patent Application Publication
(10) Pub. No.: US 2013/0224607 A1
(43) Pub. Date: Aug. 29, 2013

(54) SECONDARY BATTERY, BATTERY PACK, ELECTRIC VEHICLE, ENERGY STORAGE SYSTEM, ELECTRIC POWER TOOL, AND ELECTRONIC UNIT

(71) Applicant: Sony Corporation, (US)

(72) Inventors: Masayuki Ihara, Fukushima (JP); Tadahiko Kubota, Kanagawa (JP)

(73) Assignee: SONY CORPORATION, Tokyo (JP)

(21) Appl. No.: 13/773,910

(22) Filed: Feb. 22, 2013

(30) Foreign Application Priority Data
Feb. 28, 2012 (JP) 2012-041563
Feb. 12, 2013 (JP) 2013-024305

(51) Int. Cl. H01M 10/0569; H01M 10/0525

(52) U.S. Cl. CPC H01M 10/0569; H01M 10/0525
USPC 429/338

(57) ABSTRACT

A secondary battery includes: a cathode; an anode; and an electrolytic solution, in which an open-circuit voltage under a fully-charged state per pair of the cathode and the anode is about 4.3 V or over, and the electrolytic solution includes an unsaturated cyclic ester carbonate represented by an expression (1):

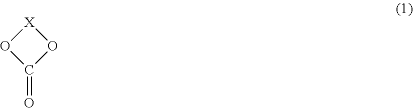

where X is a divalent group in which m-number of >C═CR1R2 and n-number of >CR3R4 are bonded in any order, R1 to R4 each are a hydrogen group, a halogen group, a monovalent hydrocarbon group, a monovalent halogenated hydrocarbon group, a monovalent oxygen-containing hydrocarbon group, or a monovalent halogenated oxygen-containing hydrocarbon group, any two or more of R1 to R4 may be bonded to one another, and m and n satisfy m≧1 and n≧0, respectively.

### CROSS REFERENCES TO RELATED APPLICATIONS

The present application claims priority to Japanese Priority Patent Application JP 2012-041563 filed in the Japan Patent Office on Feb. 28, 2012, 2013-024305 filed in the Japan Patent Office on Feb. 12, 2013, the entire content of which is hereby incorporated by reference.

### BACKGROUND

The present application relates to a secondary battery including a cathode, an anode, and an electrolytic solution, and a battery pack, an electric vehicle, a energy storage system, an electric power tool, and an electronic unit each using the secondary battery.

In recent years, various electronic units such as cellular phones and personal digital assistants (PDAs) have been widely used, and further size and weight reduction and longer life of the electronic units are desired. Accordingly, as power supplies for the electronic units, batteries, in particular, small and lightweight secondary batteries capable of obtaining high energy density have been developed. Recently, other various applications of the secondary batteries have been studied. Typical examples of the other applications include battery packs removably mounted in electronic units or the like, electric vehicles such as electric cars, energy storage systems such as home energy servers, and electric power tools such as electric drills.

Secondary batteries obtaining battery capacity with use of various charge-discharge principles have been proposed, and in particular, secondary batteries with use of insertion and extraction of an electrode reactant holds great promise, because the secondary batteries are capable of obtaining higher energy density than lead-acid batteries, nickel-cadmium batteries, and the like.

The secondary battery includes a cathode, an anode, and an electrolytic solution, and the electrolytic solution includes a solvent and an electrolyte salt. Since the electrolytic solution functioning as a medium of charge-discharge reaction exerts a large effect on performance of the secondary battery, various compositions of the electrolytic solution have been studied. More specifically, there is proposed a battery which uses a cyclic ester carbonate having one or more carbon-carbon unsaturated bonds as an additive of the electrolytic solution to suppress battery deterioration during a high-voltage charge, an explosion risk due to an increase in pressure inside the battery, and the like (for example, refer to Japanese Unexamined Patent Application Publication Nos. 2006-114388, 2001-135351, H11-191319, 2000-058122, and 2008-010414 and Japanese Unexamined Patent Application Publication (Published Japanese Translation of PCT application) No. 2004-523073). The cyclic ester carbonate of this kind is used in not only batteries using an electrolytic solution (liquid batteries) but also battery not using the electrolytic solution (solid batteries) (for example, refer to Japanese Unexamined Patent Application Publication No. 2003-017121).

### SUMMARY

In recent years, electronic units and the like using secondary batteries have higher performance and more functions; therefore, a further improvement in battery characteristics of the secondary batteries is desired.

It is desirable to provide a secondary battery, a battery pack, an electric vehicle, an energy storage system, an electric power tool, and an electronic unit which each are capable of obtaining superior battery characteristics.

According to an embodiment of the application, there is provided a secondary battery including: a cathode; an anode; and an electrolytic solution, in which an open-circuit voltage under a fully-charged state per pair of the cathode and the anode is about 4.3 V or over, and the electrolytic solution includes an unsaturated cyclic ester carbonate represented by an expression (1):

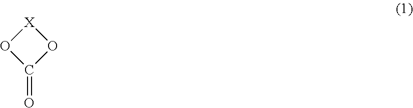

where X is a divalent group in which m-number of >C═CR1R2 and n-number of >CR3R4 are bonded in any order, R1 to R4 each are a hydrogen group, a halogen group, a monovalent hydrocarbon group, a monovalent halogenated hydrocarbon group, a monovalent oxygen-containing hydrocarbon group, or a monovalent halogenated oxygen-containing hydrocarbon group, any two or more of R1 to R4 may be bonded to one another, and m and n satisfy m≧1 and n≧0, respectively.

According to an embodiment of the application, there is provided a battery pack including: a secondary battery; a control section controlling a usage state of the secondary battery; and a switch section switching the usage state of the secondary battery according to an instruction from the control section, in which the secondary battery includes a cathode, an anode, and an electrolytic solution, an open-circuit voltage under a fully-charged state per pair of the cathode and the anode is about 4.3 V or over, and the electrolytic solution includes an unsaturated cyclic ester carbonate represented by the above-described expression (1).

According to an embodiment of the application, there is provided an electric vehicle including: a secondary battery; a conversion section converting electric power supplied from the secondary battery into driving force; a drive section operating according to the driving force; and a control section controlling a usage state of the secondary battery, in which the secondary battery includes a cathode, an anode, and an electrolytic solution, an open-circuit voltage under a fully-charged state per pair of the cathode and the anode is about 4.3 V or over, and the electrolytic solution includes an unsaturated cyclic ester carbonate represented by the above-described expression (1).

According to an embodiment of the application, there is provided an energy storage system including: a secondary battery; one or two or more electrical units receiving electric power from the secondary battery; and a control section controlling electric power supply from the secondary battery to the electrical unit, in which the secondary battery includes a cathode, an anode, and an electrolytic solution, an open-circuit voltage under a fully-charged state per pair of the cathode and the anode is about 4.3 V or over, and the electrolytic solution includes an unsaturated cyclic ester carbonate represented by the above-described expression (1).

According to an embodiment of the application, there is provided an electric power tool including: a secondary battery; and a movable section receiving electric power from the secondary battery, in which the secondary battery includes a cathode, an anode, and an electrolytic solution, an open-circuit voltage under a fully-charged state per pair of the cathode and the anode is about 4.3 V or over, and the electrolytic solution includes an unsaturated cyclic ester carbonate represented by the above-described expression (1).

According to an embodiment of the application, there is provided an electronic unit with a secondary battery as a power supply source, the secondary battery including: a cathode; an anode; and an electrolytic solution, in which an open-circuit voltage under a fully-charged state per pair of the cathode and the anode is about 4.3 V or over, and the electrolytic solution includes an unsaturated cyclic ester carbonate represented by the above-described expression (1).

In the secondary battery according to the embodiment of the application, the open-circuit voltage under the fully-charged state per pair of the cathode and the anode is about 4.3 V or over, and the electrolytic solution includes the unsaturated cyclic ester carbonate; therefore, superior battery characteristics are obtainable. Moreover, in the battery pack, the electric vehicle, the energy storage system, the electric power tool, and the electronic unit each using the secondary battery according to the embodiment of the application, similar effects are obtainable.

It is to be understood that both the foregoing general description and the following detailed description are exemplary, and are intended to provide further explanation of the application as claimed.

Additional features and advantages are described herein, and will be apparent from the following Detailed Description and the figures.

### BRIEF DESCRIPTION OF THE FIGURES

The accompanying drawings are included to provide a further understanding of the application, and are incorporated in and constitute a part of this specification. The drawings illustrate embodiments and, together with the specification, serve to explain the principles of the application.

FIG. 1 is a sectional view illustrating a configuration of a secondary battery (cylindrical type) according to an embodiment of the application.

FIG. 2 is an enlarged sectional view illustrating a part of a spirally wound electrode body illustrated in FIG. 1.

FIG. 3 is a perspective view illustrating a configuration of another secondary battery (laminate film type) according to the embodiment of the application.

FIG. 4 is a sectional view taken along a line IV-IV of a spirally wound electrode body illustrated in FIG. 3.

FIG. 5 is a block diagram illustrating a configuration of an application example (a battery pack) of the secondary battery.

FIG. 6 is a block diagram illustrating a configuration of an application example (an electric vehicle) of the secondary battery.

FIG. 7 is a block diagram illustrating a configuration of an application example (an energy storage system) of the secondary battery.

FIG. 8 is a block diagram illustrating a configuration of an application example (an electric power tool) of the secondary battery.

### DETAILED DESCRIPTION

A preferred embodiment of the application will be described in detail below referring to the accompanying drawings. It is to be noted that description will be given in the following order.

1. Secondary Battery

1-1. Cylindrical type

1-2. Laminate film type

2. Applications of Secondary Batteries

2-1. Battery pack

2-2. Electric vehicle

2-3. Energy storage system

2-4. Electric power tool

(1. Secondary Battery)

(1-1. Cylindrical Type)

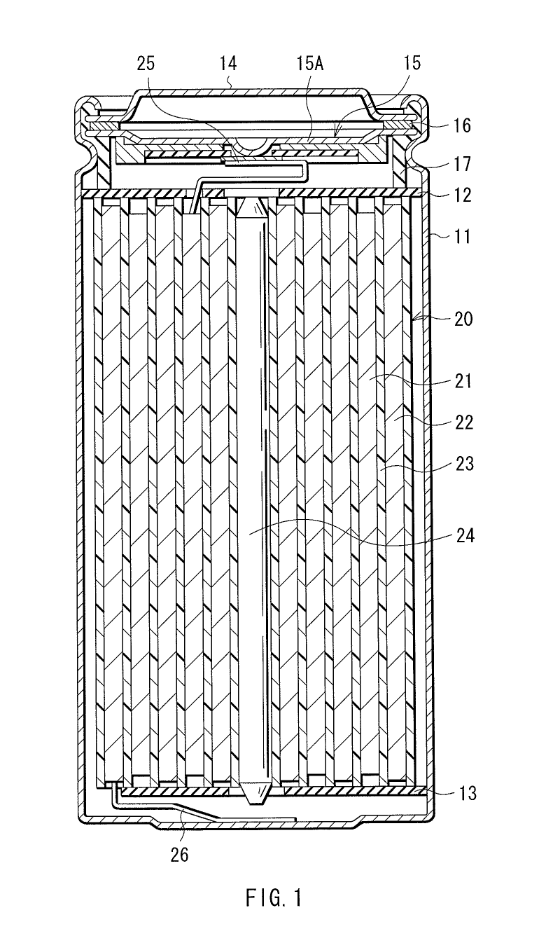

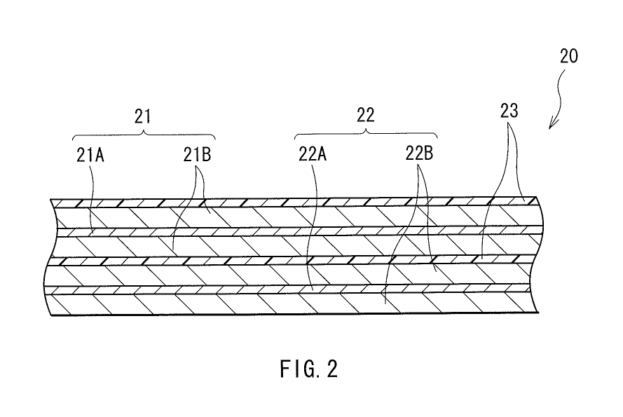

FIGS. 1 and 2 illustrate a sectional configuration of a secondary battery according to an embodiment of the application, and FIG. 2 illustrates an enlarged view of a part of a spirally wound electrode body 20 illustrated in FIG. 1.

[Entire Configuration of Secondary Battery]

The secondary battery described herein is a lithium-ion secondary battery capable of obtaining capacity of an anode 22 by insertion and extraction of Li (lithium ions) as an electrode reactant.

The secondary battery is of a so-called cylindrical type, and in the secondary battery, the spirally wound electrode body 20 and a pair of insulating plates 12 and 13 are contained in a substantially hollow cylindrical-shaped battery can 11. The spirally wound electrode body 20 is formed, for example, through laminating a cathode 21 and the anode 22 with a separator 23 in between, and then spirally winding them.

The battery can 11 has a hollow configuration in which an end of the battery can 11 is closed and the other end thereof is opened, and the battery can 11 is made of, for example, iron, aluminum, or an alloy thereof. It is to be noted that a surface of the battery can 11 may be plated with nickel or the like. The pair of insulating plates 12 and 13 are so disposed as to sandwich the spirally wound electrode body 20 and as to extend in a direction perpendicular to a peripheral winding surface of the spirally wound electrode body 20.

In the open end of the battery can 11, a battery cover 14, and a safety valve mechanism 15, and a positive temperature coefficient (PTC) device 16 are caulked by a gasket 17 to seal the battery can 11. The battery cover 14 is made of, for example, a material similar to that of the battery can 11. The safety valve mechanism 15 and the PTC device 16 are disposed inside the battery cover 14, and the safety valve mechanism 15 is electrically connected to the battery cover 14 through the PTC device 16. In the safety valve mechanism 15, when an internal pressure in the secondary battery increases to a certain extent or higher due to an internal short circuit or external application of heat, a disk plate 15A is flipped to disconnect the electrical connection between the battery cover 14 and the spirally wound electrode body 20. The PTC device 16 prevents abnormal heat generation caused by a large current. The PTC device 16 increases resistance with an increase in temperature. The gasket 17 is made of, for example, an insulating material, and its surface may be coated with asphalt.

For example, a center pin 24 is inserted into the center of the spirally wound electrode body 20, though the center pin 24 may not be included. A cathode lead 25 made of, for example, a conductive material such as aluminum is connected to the cathode 21, and an anode lead 26 made of, for example, a conductive material such as nickel is connected to the anode 22. The cathode lead 25 is connected to the safety valve mechanism 15 by welding or the like, and is electrically connected to the battery cover 14, and the anode lead 26 is connected to the battery can 11 by welding or the like, and is electrically connected to the battery can 11.

[Cathode]

The cathode 21 includes a cathode current collector 21A on one surface or both surfaces of a cathode current collector 21A. The cathode current collector 21A is formed of, for example, a conductive material such as aluminum, nickel, or stainless.

The cathode active material layer 21B includes, as cathode active materials, one or more kinds of cathode materials capable of inserting and extracting lithium ions, and may include any other material such as a cathode binder or a cathode conductor, if necessary.

As the cathode material, a lithium-containing compound is preferable, because high energy density is obtainable. Examples of the lithium-containing compound include lithium transition metal complex oxides and lithium transition metal phosphate compounds. The lithium transition metal complex oxides are oxides including Li and one or more transition metal elements as constituent elements, and the lithium transition metal phosphate compounds are phosphate compounds including Li and one or more transition metal elements as constituent elements. In particular, one or more kinds selected from a group configured of Co, Ni, Mn, and Fe are preferable as the transition metal elements, because a higher voltage is obtainable. The lithium transition metal complex oxide and the lithium transition metal phosphate compound are represented by, for example, LiₓMlO₂ and Li_{y}M2PO₄, respectively. In the expression, M1 and M2 each are one or more kinds of transition metal elements. The values of x and y depend on a charge-discharge state of the battery, and are generally within a range of 0.05≦x≦1.10 and 0.05≦y≦1.10, respectively.

Examples of the lithium transition metal complex oxide include LiCoO₂, LiNiO₂, and a lithium-nickel-based complex oxide represented by the following expression (20). Examples of the lithium transition metal phosphate compound include LiFePO₄ and LiFe₁₋ᵤMnᵤPO₄ (u<1), because high battery capacity and superior cycle characteristics are obtainable.

LiNi_{1-z}M_{z}O₂ (20)

where M is one or more kinds selected from a group configured of Co, Mn, Fe, Al, V, Sn, Mg, Ti, Sr, Ca, Zr, Mo, Tc, Ru, Ta, W, Re, Yb, Cu, Zn, Ba, B, Cr, Si, Ga, P, Sb, and Nb, and z satisfies 0.005<z<0.5.

In particular, as the lithium transition metal complex oxide, a lithium-rich compound represented by the following expression (21) is preferable, because the amount of extraction of lithium ions is increased with an increase in charge voltage, and extremely high battery capacity is obtainable accordingly. It is apparent from possible ranges of a to c that the lithium transition metal complex oxide may or may not include Ni or Co, or both as constituent elements; however, the lithium transition metal complex oxide inevitably includes Mn as a constituent element.

Li₁₊ₐMn_{b}Ni_{c}Co_{d}Oₑ (21)

where a to e satisfy 0<a<0.4, 0.4<b<1, 0≦c<0.4, 0≦d<0.4, 1.9<e<2.1, and a+b+c+d=1.

In addition to the above-described materials, examples of the cathode material include oxides, bisulfides, chalcogenides, and conductive polymers. Examples of the oxides include titanium oxide, vanadium oxide, and manganese dioxide. Examples of the bisulfides include titanium bisulfide and molybdenum sulfide. Examples of the chalcogenides include niobium selenide. Examples of the conductive polymers include sulfur, polyaniline, and polythiophene. However, the cathode material is not limited to the above-described materials.

The cathode active material layer 21B is formed by, for example, a coating method, or the like. In the coating method, for example, a particulate (powder) cathode active material is mixed with a cathode binder or the like to form a mixture, and the mixture is dispersed in a solvent such as an organic solvent, and then coating with the mixture is performed.

A thickness of the cathode active material layer 21B including the cathode active material is not specifically limited, but is preferably about 40 μm or over, and is more preferably within a range of about 40 μm to about 100 μm both inclusive. It is because even if the thickness of the cathode active material layer 21B is large, chemical stability of the electrolytic solution is maintained by an unsaturated cyclic ester carbonate which will be described later; therefore, decomposition reaction of the electrolytic solution is suppressed.

The term “thickness” described herein refers to a thickness of one cathode active material layer 21B. In other words, in the case where the cathode active material layer 21B is disposed on only one surface of the cathode current collector 21A, the “thickness” means a thickness of the cathode active material layer 21B. On the other hand, in the case where the cathode active material layers 21B are disposed on both surfaces of the cathode current collector 21A, the “thickness” means a thickness of each of the cathode active material layers 21B.

It is to be noted that, in relation to the thickness of the above-described cathode active material layer 21B, volume density of the cathode active material layer 21B is not specifically limited, but is preferably within a range of about 3.5 g/cm³ (=g/cc) to about 3.9 g/cm³ both inclusive, because high battery capacity is secured.

As the cathode binder, for example, one or more kinds of synthetic rubber or polymer materials are used. Examples of synthetic rubber include styrene butadiene-based rubber, fluorine-based rubber, and ethylene propylene diene. Examples of the polymer materials include polyvinylidene fluoride and polyimide.

As the cathode conductor, for example, one or more kinds of carbon materials are used. Examples of the cathode materials include graphite, carbon black, acetylene black, and ketjen black. It is to be noted that the cathode conductor may be a metal material, a conductive polymer, or the like, as long as the metal material, the conductive polymer, or the like is a material having electrical conductivity.

[Anode]

The anode 22 includes an anode active material layer 22B on one surface or both surfaces of an anode current collector 22A.

The anode current collector 22A is made of, for example, a conductive material such as copper, nickel, or stainless. The surfaces of the anode current collector 22A are preferably roughened, because adhesion of the anode active material layer 22B to the anode current collector 22A is improved by a so-called anchor effect. In this case, the surfaces of the anode current collector 22A may be roughened at least in a region facing the anode active material layer 22B. Examples of a roughening method include a method of forming microparticles by electrolytic treatment. The electrolytic treatment is a method of forming microparticles on the surfaces of the anode current collector 22A in an electrolytic bath by an electrolytic method to form roughened surfaces. Copper foil formed by the electrolytic treatment is generally called electrolytic copper foil.

The anode active material layer 22B includes, as anode active materials, one or more kinds of anode materials capable of inserting and extracting lithium ions, and may include any other material such as an anode binder or an anode conductor, if necessary. Details of the anode binder and the anode conductor are, for example, similar to those of the cathode binder and the cathode conductor, respectively. However, the chargeable capacity of the anode material is larger than the discharge capacity of the cathode 21 to prevent unintended deposition of lithium metal during charge. In other words, an electrochemical equivalent of the anode material capable of inserting and extracting lithium ions is preferably larger than an electrochemical equivalent of the cathode 21.

Examples of the anode material include carbon materials, because variations in crystal structure during insertion and extraction of lithium ions are very small, and high energy density and superior cycle characteristics are obtainable accordingly. Moreover, it is because the carbon materials function as anode conductors. Examples of the carbon materials include graphitizable carbon, non-graphitizable carbon having the (002) plane with a surface separation of 0.37 nm or over, and graphite having the (002) plane with a surface separation of 0.34 nm or less. More specific examples of the carbon materials include pyrolytic carbons, cokes, glass-like carbon fibers, an organic polymer compound fired body, activated carbon, and carbon blacks. Cokes include pitch coke, needle coke, and petroleum coke. The organic polymer compound fired body is formed through firing (carbonizing) a polymer compound such as a phenolic resin or a furan resin at an appropriate temperature. In addition, as the carbon material, low-crystalline carbon or amorphous carbon subjected to heat treatment at approximately 1000° C. or less may be used. It is to be noted that the carbon material may have any one of a fibrous shape, a spherical shape, a granular shape, and a scale-like shape.

Examples of the anode material include a material (a metal-based material) including one or more kinds selected from a group configured of metal elements and metalloid elements as constituent elements, because high energy density is obtainable. The metal-based material may be any one of the simple substances, alloys, and compounds of metal elements and metalloid elements, a material including two or more kinds selected from them, or a material including a phase of one or more kinds selected from them at least in part. It is to be noted that the alloy refers to an alloy including two or more kinds of metal elements as well as an alloy including one or more kinds of metal elements and one or more kinds of metalloid elements. Moreover, the alloy may include a non-metal element. The texture of the alloy may be a solid solution, a eutectic (eutectic mixture), an intermetallic compound, or the coexistence of two or more kinds selected from them.

Examples of the above-described metal elements and the above-described metalloid element include one or more kinds selected from metal elements and metalloid elements capable of forming an alloy with Li. Specific examples include Mg, B, Al, Ga, In, Si, Ge, Sn, Pb, Bi, Cd, Ag, Zn, Hf, Zr, Y, Pd, and Pt. In particular, one or both of Si and Sn are preferable, because Si and Sn have a high capability of inserting and extracting lithium ions, and high energy density is obtainable accordingly.

A material including one or both of Si and Sn may be the simple substance, an alloy, or a compound of Si or Sn, a material including two or more kinds selected from them, or a material including a phase of one or more kinds selected from them at least in part. It is to be noted that the simple substance is a simple substance (which may include trace amounts of impurities) in a general sense, and does not necessarily have a purity of 100%.

Examples of alloys of Si include materials including, as constituent elements other than Si, one or more kinds selected from a group configured of Sn, Ni, Cu, Fe, Co, Mn, Zn, In, Ag, Ti, Ge, Bi, Sb, Cr, and the like. Examples of compounds of Si include materials including, as constituent elements other than Si, one or more kinds selected from a group configured of C, O, and the like. It is to be noted that the compound of Si may include, as constituent elements other than Si, one or more kinds selected from the elements described in the alloy of Si.

Examples of the alloy of Si and the compound of Si include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), and LiSiO. It is to be noted that “v” in SiOᵥ may be within a range of 0.2<v<1.4.

Examples of the alloy of Sn include a material including, as constituent elements other than Sn, one or more kinds selected from a group configured of Si, Ni, Cu, Fe, Co, Mn, Zn, In, Ag, Ti, Ge, Bi, Sb, Cr, and the like. Examples of the compound of Sn include a material including, as constituent elements other than Sn, one or more kinds selected from a group configured of C, O, and the like. It is to be noted that the compound of Sn may include, as constituent elements other than Sn, one or more kinds selected from the elements described in the alloy of Sn. Examples of the alloy of Sn and the compound of Sn include SnO_{w} (0<w≦2), SnSiO₃, LiSnO, and Mg₂Sn.

Moreover, as the material including Sn, for example, a material including Sn as a first constituent element, and a second constituent element and a third constituent element is preferable. Examples of the second constituent element include one or more kinds selected from a group configured of Co, Fe, Mg, Ti, V, Cr, Mn, Ni, Cu, Zn, Ga, Zr, Nb, Mo, Ag, In, Ce, Hf, Ta, W, Bi, Si, and the like. Examples of the third constituent element include one or more kinds selected from a group configured of B, C, Al, P, and the like. When the second and third constituent elements are included, high battery capacity and superior cycle characteristics are obtainable.

In particular, a material including Sn, Co, and C (a SnCoC-containing material) is preferable. As the composition of the SnCoC-containing material, for example, the C content is within a range of 9.9 mass % to 29.7 mass % both inclusive, and the ratio of the Sn content and the Co content (Co/(Sn+Co)) is within a range of 20 mass % to 70 mass % both inclusive, because high energy density is obtainable in such a composition range.

The SnCoC-containing material includes a phase including Sn, Co, and C, and the phase preferably has a low crystalline structure or an amorphous structure. The phase is a reactive phase capable of reacting with Li, and superior characteristics are obtainable by the presence of the phase. The half-width of a diffraction peak of the phase obtained by X-ray diffraction is preferably 1° or over at a diffraction angle of 2θ in the case where a CuKα ray is used as a specific X ray and the sweep rate is 1°/min, because lithium ions are inserted or extracted more smoothly, and reactivity with an electrolytic solution is reduced. It is to be noted that the SnCoC-containing material may include a phase including the simple substance of each constituent element or a part of the constituent element in addition to a low crystalline phase or an amorphous phase.

Whether or not the diffraction peak obtained by X-ray diffraction corresponds to a reactive phase capable of reacting with Li is easily determined by a comparison between X-ray diffraction charts before and after electrochemical reaction with Li. For example, when the position of the diffraction peak before the electrochemical reaction with Li is different from the position of the diffraction peak after the electrochemical reaction, the diffraction peak corresponds to a reactive phase capable of reacting with Li. In this case, the diffraction peak of a low crystalline phase or an amorphous phase is detected within a range of, for example, 28=20° to 50° both inclusive. Such a reactive phase includes the above-described constituent elements, and it is considered that the reactive phase is changed to be low crystalline or amorphous mainly by the presence of C.

In the SnCoC-containing material, at least a part of C as a constituent element is preferably bonded to a metal element or a metalloid element as another constituent element, because cohesion or crystallization of Sn or the like is suppressed. The bonding state of an element is checked by, for example, X-ray photoelectron spectroscopy (XPS). In a commercially available unit, an Al—Kα ray or an Mg—Kα ray is used as a soft X ray. In the case where at least a part of C is bonded to a metal element, a metalloid element, or the like, the peak of a composite wave of the is orbit (C1s) of C is observed in a region lower than 284.5 eV. It is to be noted that energy calibration is performed to allow the peak of the 4f orbit (Au4f) of an Au atom to be obtained at 84.0 eV. In this case, in general, since surface contamination carbon is present on a material surface, the peak of C1s of the surface contamination carbon is defined at 284.8 eV, and is used as energy reference. In an XPS measurement, the waveform of the peak of C1s is obtained as a form including the peak of the surface contamination carbon and the peak of C in the SnCoC-containing material; therefore, the peak of the surface contamination carbon and the peak of carbon are separated by, for example, analysis with use of commercially available software. In the analysis of the waveform, the position of a main peak existing on a lowest binding energy side is used as an energy reference (284.8 eV).

It is to be noted that the SnCoC-containing material is not limited to a material configured of only Sn, Co, and C as constituent elements. In other words, the SnCoC-containing material may further include one or more kinds selected from a group consisting of Si, Fe, Ni, Cr, In, Nb, Ge, Ti, Mo, Al, P, Ga, Bi, and the like as constituent elements, if necessary.

In addition to the SnCoC-containing material, a material including Sn, Co, Fe, and C (an SnCoFeC-containing material) is also preferable. The composition of the SnCoFeC-containing material may be arbitrarily set. For example, a composition with a small Fe content is set as follows. The C content is within a range of 9.9 mass % to 29.7 mass % both inclusive, the Fe content is within a range of 0.3 mass % to 5.9 mass % both inclusive, and the ratio of the Sn content and the Co content (Co/(Sn+Co)) is within a range of 30 mass % to 70 mass % both inclusive. Moreover, for example, a composition with a large Fe content is set as follows. The C content is within a range of 11.9 mass % to 29.7 mass % both inclusive, and the ratio of the Sn content, the Co content, and the Fe content ((Co+Fe)/(Sn+Co+Fe)) is within a range of 26.4 mass % to 48.5 mass % both inclusive, and the ratio of the Co content and the Fe content (Co/(Co+Fe)) is within a range of 9.9 mass % to 79.5 mass % both inclusive, because in such a composition range, high energy density is obtainable. The SnCoFeC-containing material has physical properties (such as half-width) similar to those of the above-described SnCoC-containing material.

In addition, examples of the anode material may include metal oxides and polymer compounds. Examples of metal oxides include iron oxide, ruthenium oxide, and molybdenum oxide. Examples of the polymer compounds include polyacetylene, polyaniline, and polypyrrole.

The anode active material layer 22B is formed by, for example, a coating method, a vapor-phase method, a liquid-phase method, a spraying method, a firing method (a sintering method), or a combination of two or more kinds of the methods. In the coating method, for example, a particulate anode active material is mixed with a binder or the like to form a mixture, and the mixture is dispersed in a solvent such as an organic solvent, and then the anode current collector 22A is coated with the mixture. Examples of the vapor-phase method include a physical deposition method and a chemical deposition method. More specific examples of the vapor-phase method include a vacuum deposition method, a sputtering method, an ion plating method, a laser ablation method, a thermal chemical vapor deposition method, a chemical vapor deposition (CVD) method, and a plasma chemical vapor deposition method. Examples of the liquid-phase method include an electrolytic plating method, and an electroless plating method. In the spray method, the anode active material in a molten state or a semi-molten state is sprayed on the anode current collector 22A. In the firing method, for example, after the anode current collector 22A is coated with use of the coating method, the anode current collector 22A is heated at a higher temperature than the melting point of the anode binder or the like. As the firing method, known techniques such as an atmosphere firing method, a reaction firing method, and a hot press firing method may be used.

A thickness of the anode active material layer 22B including the anode active material is not specifically limited, but is preferably about 20 μm or over, and is more preferably within a range of about 20 μm to about 100 μm both inclusive. It is because even if the thickness of the anode active material layer 22B is large, chemical stability of the electrolytic solution is maintained by the unsaturated cyclic ester carbonate which will be described later; therefore, decomposition reaction of the electrolytic solution is suppressed. As with the thickness of the cathode active material layer 21B, the term “thickness” described herein refers to a thickness of one anode active material layer 22B. A method of forming the anode active material layer 22B is not specifically limited, as long as one kind or two or more kinds selected from the above-described coating method, the above-described vapor-phase method, and the like are used.

It is to be noted that, in relation to the thickness of the above-described anode active material layer 22B, volume density of the anode active material layer 22B is not specifically limited, but is preferably within a range of about 1.4 g/cm³ (=g/cc) to about 1.8 g/cm³ both inclusive, because high battery capacity is secured.

[Separator]

The separator 23 isolates between the cathode 21 and the anode 22 to allow lithium ions to pass therethrough while preventing a short circuit of a current due to contact between the cathode 21 and the anode 22. The separator 23 is configured of, for example, a porous film of a synthetic resin or ceramic, and may be configured of a laminate film formed through laminating two or more kinds of porous films. Examples of the synthetic resin include polytetrafluoroethylene, polypropylene, and polyethylene.

In particular, for example, the separator 23 may include the above-described porous film (a base layer) and a polymer compound layer disposed on one surface or both surfaces of the base layer, because adhesion of the separator 23 to the cathode 21 and the anode 22 is improved, and distortion of the spirally wound electrode body 20 is suppressed accordingly. Thus, decomposition reaction of the electrolytic solution is suppressed, and leakage of the electrolytic solution with which the base layer is impregnated is suppressed. Therefore, even if charge and discharge are repeated, resistance of the secondary battery is less likely to increase, and battery swelling is suppressed.

The polymer compound layer includes, for example, a polymer material such as polyvinylidene fluoride, because the polymer material is superior in physical strength and is electrochemically stable. However, the polymer material may be any polymer material other than polyvinylidene fluoride. For example, the polymer compound layer is formed through preparing a solution in which the polymer material is dissolved, and then coating the base layer with the solution, and drying the base layer. It is to be noted that the base layer may be immersed in the solution, and then be dried.

[Electrolytic Solution]

The separator 23 is impregnated with an electrolytic solution which is a liquid electrolyte. The electrolytic solution includes one or more kinds selected from unsaturated cyclic ester carbonates represented by the following expression (1) (hereinafter simply referred to as “unsaturated cyclic ester carbonates”). The electrolytic solution may include other materials such as a solvent and an electrolyte salt.

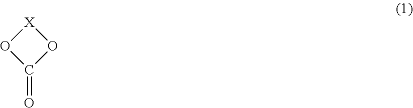

where X is a divalent group in which m-number of >C═CR1R2 and n-number of >CR3R4 are bonded in any order, R1 to R4 each are a hydrogen group, a halogen group, a monovalent hydrocarbon group, a monovalent halogenated hydrocarbon group, a monovalent oxygen-containing hydrocarbon group, or a monovalent halogenated oxygen-containing hydrocarbon group, any two or more of R1 to R4 may be bonded to one another, and m and n satisfy m≧1 and n≧0, respectively.

The unsaturated cyclic ester carbonate is a cyclic ester carbonate having one or more unsaturated bonds (carbon-carbon double bonds; >C═C<). The electrolytic solution includes the unsaturated cyclic ester carbonate, because even if an upper limit of a charge voltage, that is, an open-circuit voltage under a fully-charged state per pair of the cathode 21 and the anode 22 is set to be as high as 4.3 V or over, chemical stability of the electrolytic solution is maintained.

More specifically, in the case where the electrolytic solution does not include the unsaturated cyclic ester carbonate, when the upper limit of the charge voltage is as high as 4.3 V or over, many lithium ions are extracted from the cathode 21, and high energy density is obtained accordingly. On the other hand, chemical stability of the electrolytic solution is pronouncedly deteriorated; therefore, decomposition reaction of the electrolytic solution is accelerated. Therefore, while high battery capacity is obtainable, cycle characteristics and the like are deteriorated. Thus, a tendency to accelerate the decomposition reaction of the electrolytic solution is noticeable specifically under severe conditions such as a high-temperature environment.

On the other hand, in the case where the electrolytic solution includes the unsaturated cyclic ester carbonate, when the upper limit of the charge voltage is as high as 4.3 V or over, high energy density is obtainable as in the case where the electrolytic solution does not include the saturated cyclic ester carbonate. Moreover, the chemical stability of the electrolytic solution is maintained by the unsaturated cyclic ester carbonate; therefore, the decomposition reaction of the electrolytic solution is suppressed. Accordingly, high battery capacity is obtainable, and the cycle characteristics and the like are secured.

In the expression (1), X is a group in which m-number of >C═CR1R2 and n-number of >CR3R4 are bonded together to form a divalent group (having one bond at each of both ends thereof) as a whole. Groups adjacent to each other (bonded to each other) may be groups of a same kind such as >C═CR1R2 or groups of different kinds such as >C═CR1-R2 and >CR3R4. In other words, the number (m) of >C═CR1R2 and the number (n) of >CR3R4 used to form a divalent group are arbitrary, and they are bonded in any order.

While >C═CR1R2 is a divalent unsaturated group having the above-described carbon-carbon double bond, >CR3R4 is a divalent saturated group not having a carbon-carbon double bond. Since n≧0 is established, the saturated group >CR3R4 may not be included in X, and since m≧1 is established, it is necessary for X to include one or more of the unsaturated groups >C═CR1R2. Accordingly, X may be configured of only >C═CR1R2, or may be configured of both >C═CR1R2 and >CR3R4, because it is necessary for the unsaturated cyclic ester carbonate to include one or more unsaturated groups in a chemical structure of the unsaturated cyclic ester carbonate.

The values of m and n are not specifically limited, as long as the values of m and n satisfy m≧1 and n≧0, respectively. In particular, in the case where >C═CR1R2 is >C═CH₂ and >CR3R4 is >CH₂, the values m and n preferably satisfy (m+n)≦5, because the number of carbon atoms in X is not too large, and solubility and compatibility of the unsaturated cyclic ester carbonate are secured accordingly.

It is to be noted that any two or more of R1 to R4 in >C═CR1R2 and >CR3R4 may be bonded to one another, and a ring may be formed of the bonded groups. For example, R1 and R2 may be bonded to each other, R3 and R4 may be bonded to each other, or R2, R3 and R4 may be bonded to one another.

R1 to R4 will be described in detail below. R1 to R4 may be groups of a same kind or groups of different kinds, and any two or three of R1 to R4 may be groups of a same kind.

The kinds of R1 to R4 are not specifically limited, as long as they each are a hydrogen group, a halogen group, a monovalent hydrocarbon group, a monovalent halogenated hydrocarbon group, a monovalent oxygen-containing hydrocarbon group, or a monovalent halogenated oxygen-containing hydrocarbon group, because the above-described advantages are obtainable without relying on the kinds of R1 to R4 through having one or more carbon-carbon double bonds (>C═CR1R2) in X.

As the halogen group, for example, one or more kinds selected from a group configured of a fluorine group (—F), a chlorine group (—Cl), a bromine group (—Br), iodine group (—I), and the like are used, and in particular, the fluorine group is preferable, because a higher effect is obtainable.

The “monovalent hydrocarbon group” is a generic name of a monovalent group configured of C and H, and may have a straight-chain structure or a branched structure with one or more side chains. Examples of the monovalent hydrocarbon group include an alkyl group having 1 to 12 carbon atoms, an alkenyl group having 2 to 12 carbon atoms, an alkynyl group having 2 to 12 carbon atoms, an aryl group having 6 to 18 carbon atoms, and a cycloalkyl group having 3 to 18 carbon atoms, because the above-described advantages are obtainable while securing solubility, compatibility, and the like of the unsaturated cyclic ester carbonate.

More specifically, examples of the alkyl group include a methyl group (—CH₃), an ethyl group (—C₂H₅), and a propyl group (—C₃H₇). Examples of the alkenyl group include a vinyl group (—CH═CH₂) and an allyl group (—CH₂—CH═CF₁₂). Examples of the alkynyl group include an ethynyl group (—C≡CH). Examples of the aryl group include a phenyl group and a naphthyl group. Examples of the cycloalkyl group include a cyclopropyl group, a cyclobutyl group, a cyclopentyl group, a cyclohexyl group, a cycloheptyl group, and a cyclooctyl group.

The “monovalent oxygen-containing hydrocarbon group” is a generic name of a monovalent group configured of C, H, and O, and is, for example, an alkoxy group having 1 to 12 carbon atoms, because the above-described advantages are obtainable while securing solubility, compatibility, and the like of the unsaturated cyclic ester carbonate. Specific examples of the alkoxy group include a methoxy group (—OCH₃) and an ethoxy group (—OC₂H₅).

It is to be noted that R1 to R4 each may be a group in which two or more kinds of the groups listed as candidates of R1 to R4 are bonded to form a monovalent group as a whole. Examples of the group include a group in which an alkyl group and an aryl group are bonded together, and a group in which an alkyl group and a cycloalkyl group are bonded together. More specific examples of the group in which the alkyl group and the aryl group are bonded together include a benzyl group.

The “monovalent halogenated hydrocarbon group” is a group in which one or more of hydrogen groups (—H) in the above-described monovalent hydrocarbon group are substituted with a halogen group (halogenated). Likewise, the “monovalent halogenated oxygen-containing hydrocarbon group” is a group in which one or more of hydrogen groups in the above-described monovalent oxygen-containing group are substituted with a halogen group. In any of the cases, the kind of the halogen group with which the hydrogen group is substituted is similar to that of the above-described halogen group.

The monovalent halogenated hydrocarbon group is, for example, a group obtained through halogenating the above-described alkyl group or the like, that is, a group in which one or more of hydrogen groups in the above-described alkyl group or the like are substituted with a halogen group. More specific examples of the group obtained through halogenating the alkyl group or the like include a trifluoromethyl group (—CF₃) and a pentafluoroethyl group (—C₂F₅). Moreover, the monovalent halogenated oxygen-containing hydrocarbon group is, for example, a group in which one or more hydrogen groups in the above-described alkoxy group or the like are substituted with a halogen group. More specific examples of the group obtained through halogenating the alkoxy group or like include a trifluoromethoxy group (—OCF₃) and a pentafluoroethoxy group (—OC₂F₅).

It is to be noted that R1 to R4 each may be a group other than the above-described groups. More specifically, R1 to R4 each may be a derivative of any one of the above-described groups. The derivative is a group obtained through introducing one or more substituent groups into any one of the above-described groups, and the kind of the substituent group is arbitrarily selected.

In particular, the unsaturated cyclic ester carbonate is preferably represented by the following expression (2) or (3), because the unsaturated cyclic ester carbonate is easily synthesized in addition to obtaining the above-described advantages.

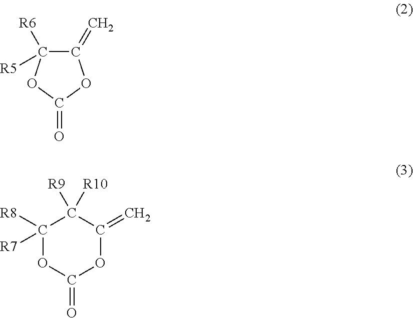

where R5 to R10 each are a hydrogen group, a halogen group, a monovalent hydrocarbon group, a monovalent halogenated hydrocarbon group, a monovalent oxygen-containing hydrocarbon group, or a monovalent halogenated oxygen-containing hydrocarbon group, R5 and R6 may be bonded to each other, and any two or more of R7 to R10 may be bonded to one another.

In a relationship between the expressions (1) and (2), the unsaturated cyclic ester carbonate represented by the expression (2) includes, as X in the expression (1), one unsaturated group (>C═CH₂) corresponding to >C═CR1R2 and one saturated group (>CR5R6) corresponding to >CR3R4. On the other hand, in a relationship between the expressions (1) and (3), the unsaturated cyclic ester carbonate represented by the expression (3) includes, as X, one unsaturated group (>C═CH₂) corresponding to >C═CR1R2 and two saturated groups (>CR7R8 and >CR9R10) corresponding to >CR3R4. It is to be noted that one unsaturated group and two saturated group are bonded in order of >CR7R8, >CR9R10, and >C═CH₂.

Details of R5 and R6 in the expression (2) and R7 to R10 in the expression (3) are similar to those of R1 to R4 in the expression (1), and will not be further described.

Specific examples of the unsaturated cyclic ester carbonate are represented by the following expressions (1-1) to (1-56), and the unsaturated cyclic ester carbonate also includes a geometric isomer. Specific examples of the unsaturated cyclic ester carbonate are not limited to those represented by the expressions (1-1) to (1-56).

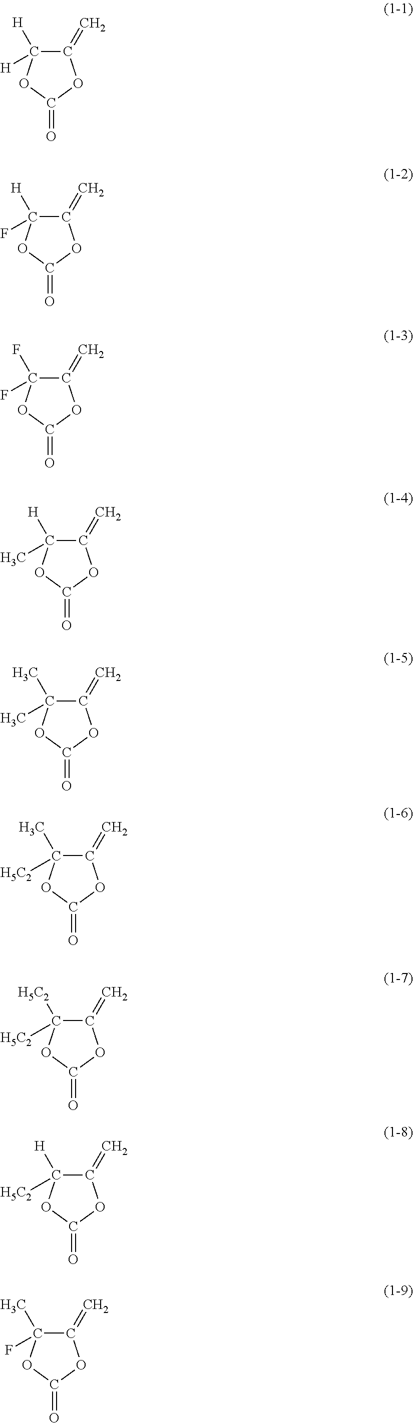

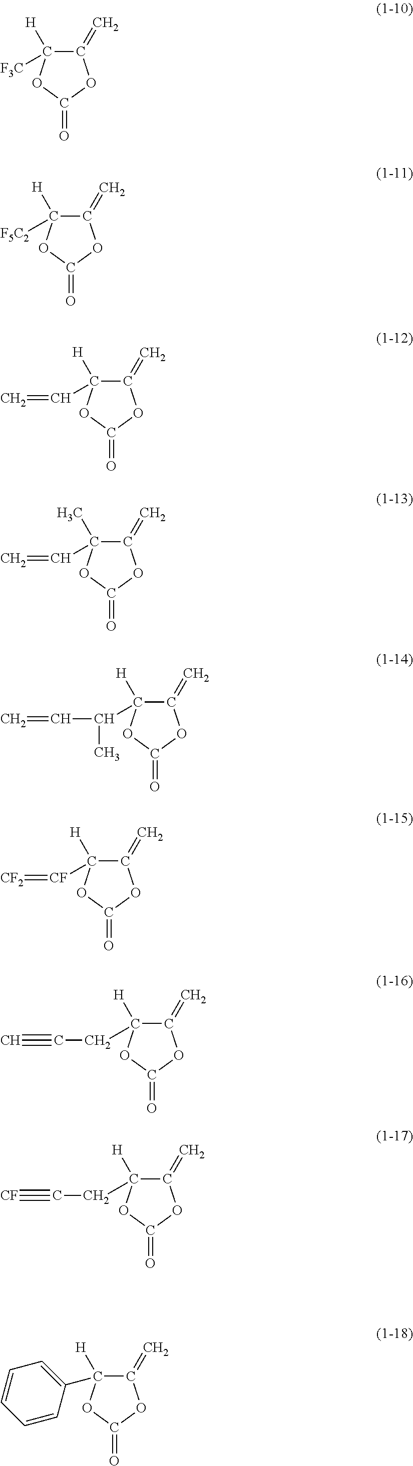

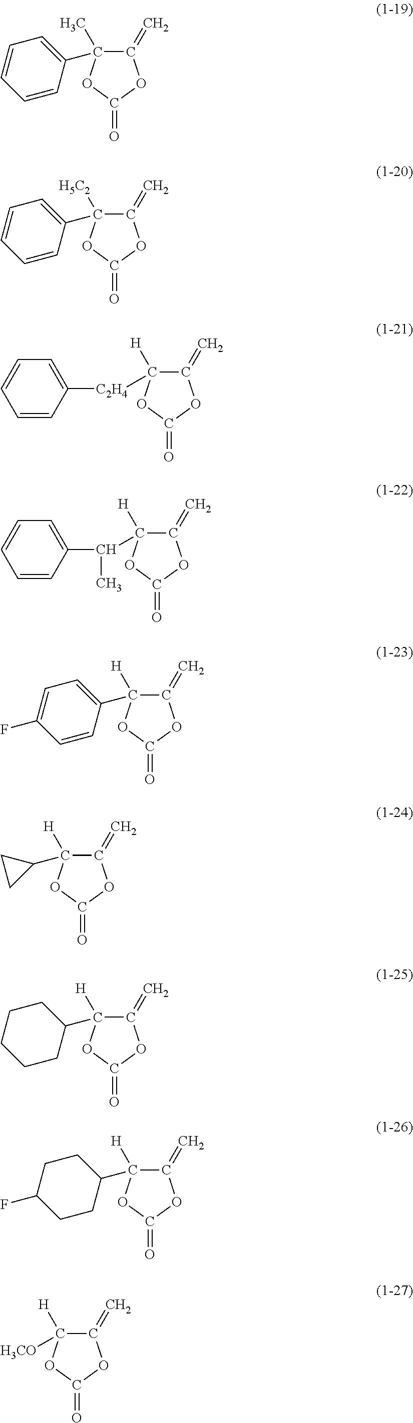

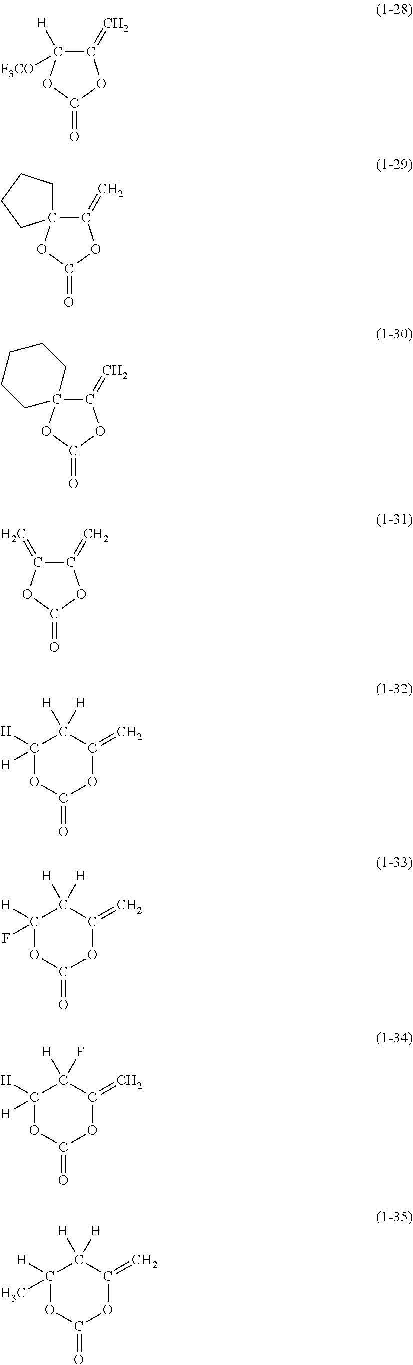

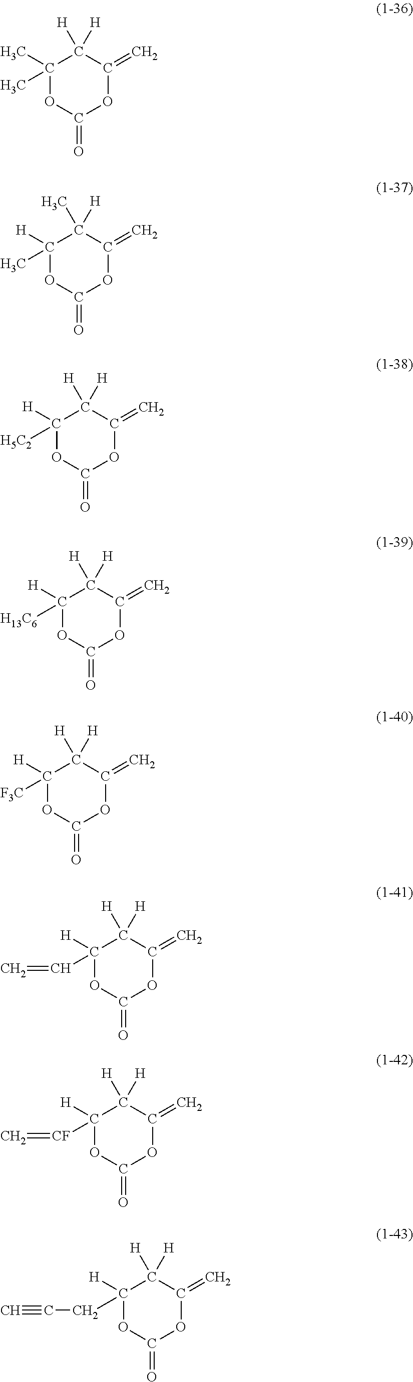

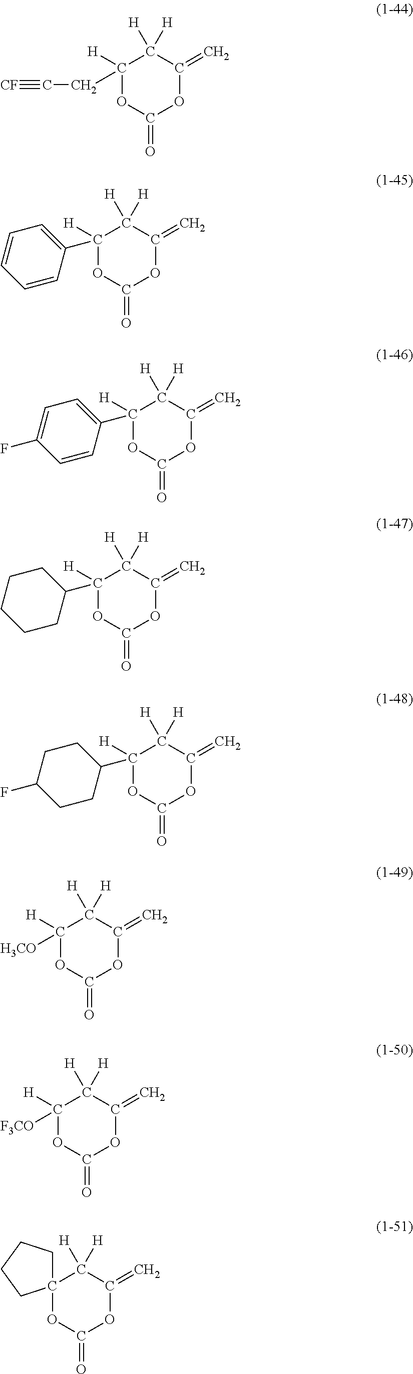

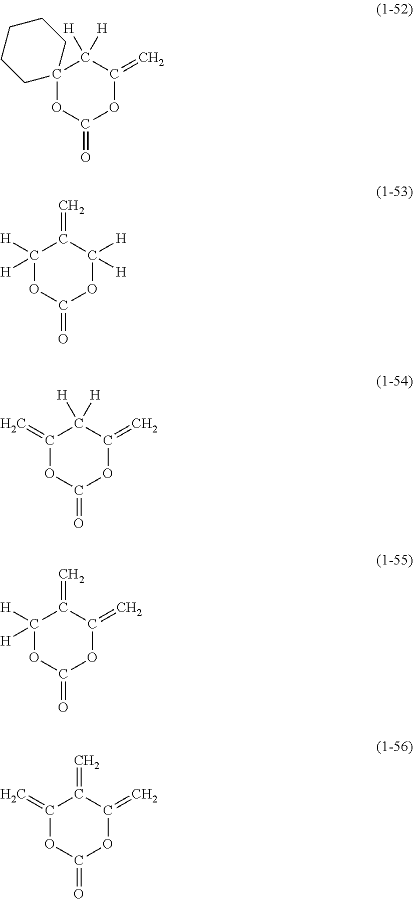

In particular, the expression (1-1) or the like corresponding to the expression (2) or the expression (1-32) or the like corresponding to the expression (3) is preferable, because a higher effect is obtainable.

The content of the unsaturated cyclic ester carbonate in the electrolytic solution is not specifically limited, but is preferably within a range of 0.01 wt % to 10 wt % both inclusive, more preferably within a range of 1 wt % to 10 wt %, and further more preferably within a range of 2 wt % to 10 wt % both inclusive, because a higher effect is obtainable.

The solvent used in the electrolytic solution includes one or more kinds of nonaqueous solvents such as organic solvents (except for the above-described unsaturated cyclic ester carbonate).

Examples of the nonaqueous solvent include cyclic ester carbonates, chain ester carbonates, lactones, chain carboxylates, and nitriles, because superior battery capacity, superior cycle characteristics, superior storage characteristics, and the like are obtainable. Examples of the cyclic ester carbonates include ethylene carbonate, propylene carbonate, and butylene carbonate, and examples of the chain ester carbonates include dimethyl carbonate, diethyl carbonate, ethyl methyl carbonate, and methyl propyl carbonate. Examples of the lactones include γ-butyrolactone and γ-valerolactone. Examples of the carboxylates include methyl acetate, ethyl acetate, methyl propionate, ethyl propionate, methyl butyrate, methyl isobutyrate, methyl trimethylacetate, and ethyl trimethylacetate. Examples of nitriles include acetonitrile, glutaronitrile, adiponitrile, methoxyacetonitrile, and 3-methoxypropionitrile.

Other examples of the nonaqueous solvent include 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N,N-dimethylformamide, N-methylpyrrolidinone, N-methyloxazolidinone, N,N′-dimethylimidazolidinone, nitromethane, nitroethane, sulfolane, trimethyl phosphate, and dimethyl sulfoxide, because similar advantages are obtainable.

In particular, one or more kinds selected from a group configured of ethylene carbonate, propylene carbonate, dimethyl carbonate, dimethyl carbonate, diethyl carbonate, and ethyl methyl carbonate are preferable, because superior battery capacity, superior cycle characteristics, superior storage characteristics, and the like are obtainable. In this case, a combination of a high-viscosity (high-permittivity) solvent (for example, relative permittivity ε≧30) such as ethylene carbonate or propylene carbonate and a low-viscosity solvent (for example, viscosity≦1 mPa·s) such as dimethyl carbonate, ethyl methyl carbonate, or diethyl carbonate is more preferable, because the dissociation property of the electrolyte salt and ion mobility are improved.

In particular, the solvent preferably includes one or more kinds selected from other unsaturated cyclic ester carbonates represented by the following expressions (4) and (5), because a stable protective film is formed on a surface of the anode 22 mainly during charge and discharge, thereby suppressing decomposition reaction of the electrolytic solution. The kinds of R11 and R12 may be the same as or different from each other. The kinds of R13 to R16 may be the same as or different from one another, or two or more of R13 to R16 may be the same as one another. The content of the other unsaturated cyclic ester carbonate in the solvent is not specifically limited, but is, for example, within a range of 0.01 wt % to 10 wt % both inclusive. It is to be noted that specific examples of the other unsaturated cyclic ester carbonate are not limited to compounds which will be described below.

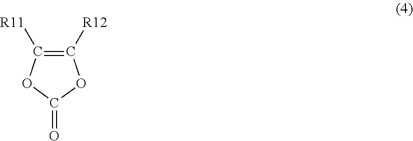

where R11 and R12 each are a hydrogen group or an alkyl group.

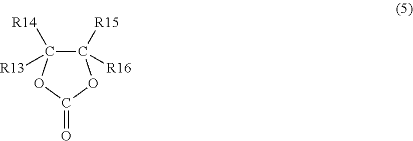

where R13 to R16 each are a hydrogen group, an alkyl group, a vinyl group, or an allyl group, and one or more of R13 to R16 are a vinyl group or an allyl group.

The unsaturated cyclic ester carbonate represented by the expression (4) is a vinylene carbonate-based compound. The kinds of R11 and R12 are not specifically limited, as long as R11 and R12 each are, for example, a hydrogen group or an alkyl group. The alkyl group is, for example, a methyl group or an ethyl group, and the alkyl group preferably has 1 to 12 carbon atoms, because superior solubility and superior compatibility are obtainable. Specific examples of the vinylene carbonate-based compound include vinylene carbonate (1,3-dioxol-2-one), methyl vinylene carbonate (4-methyl-1,3-dioxol-2-one), ethyl vinylene carbonate (4-ethyl-1,3-dioxol-2-one), 4,5-dimethyl-1,3-dioxol-2-one, and 4,5-diethyl-1,3-dioxol-2-one. It is to be noted that R11 and R12 may be a group in which one or more hydrogen groups in the alkyl group are substituted with a halogen group. Specific examples of the vinylene carbonate-based compound in this case include 4-fluoro-1,3-dioxol-2-one and 4-trifluoromethyl-1,3-dioxol-2-one. In particular, vinylene carbonate is preferable, because vinylene carbonate is easily available, and a high effect is obtainable.

The other unsaturated cyclic ester carbonate represented by the expression (5) is a vinyl ethylene carbonate-based compound. The kinds of R13 to R16 are not specifically limited, as long as R13 to R16 each are a hydrogen group, an alkyl group, a vinyl group, or an allyl group under a condition that one or more of R13 to R16 are a vinyl group or an allyl group. The kind of the alkyl group and the number of carbon atoms in the alkyl group are similar to those in R11 and R12. Specific examples of the vinyl ethylene carbonate-based compound include vinyl ethylene carbonate (4-vinyl-1,3-dioxolane-2-one), 4-methyl-4-vinyl-1,3-dioxolane-2-one, 4-ethyl-4-vinyl-1,3-dioxolane-2-one, 4-n-propyl-4-vinyl-1,3-dioxolane-2-one, 5-methyl-4-vinyl-1,3-dioxolane-2-one, 4,4-divinyl-1,3-dioxolane-2-one, and 4,5-divinyl-1,3-dioxolane-2-one. In particular, vinyl ethylene carbonate is preferable, because vinyl ethylene carbonate is easily available, and a high effect is obtainable. All of R13 to R16 may be vinyl groups or allyl groups, or vinyl groups and allyl groups may be mixed in R13 to R16.

It is to be noted that the other unsaturated cyclic ester carbonate may be catechol carbonate having a benzene ring, in addition to the compounds represented by the expressions (4) and (5).

Moreover, the solvent preferably includes one or more kinds selected from halogenated ester carbonates represented by the following expressions (6) and (7), because a stable protective film is formed on the surface of the anode 22 mainly during charge and discharge, thereby suppressing decomposition reaction of the electrolytic solution. The halogenated ester carbonate represented by the expression (6) is a cyclic ester carbonate (a halogenated cyclic ester carbonate) having one or more halogen atoms as constituent elements. The halogenated ester carbonate represented by the expression (7) is a chain ester carbonate (halogenated chain ester carbonate) having one or more halogen atoms as constituent elements. It is to be noted that the kinds of R17 to R20 may be the same as or different from one another, and two or more of R17 to R20 may be the same as one another. The same applies to R21 to R26. The content of the halogenated ester carbonate in the solvent is not specifically limited, but is, for example, within a range of 0.01 wt % to 50 wt % both inclusive. However, specific examples of the halogenated ester carbonate are not limited to compounds which will be described below.

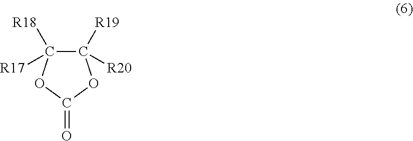

where R17 to R20 each are a hydrogen group, a halogen group, an alkyl group, or a halogenated alkyl group, and one or more of R17 to R20 are a halogen group or a halogenated alkyl group.

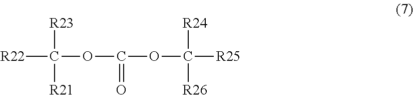

where R21 to R26 each are a hydrogen group, a halogen group, an alkyl group, or a halogenated alkyl group, and one or more of R21 to R26 are a halogen group or a halogenated alkyl group.

The kind of halogen is not specifically limited; however, in particular, fluorine (F), chlorine (Cl) or bromine (Br) is preferable, and fluorine is more preferable, because a higher effect than that of other halogens is obtainable. The number of halogen atoms is more preferably 2 than 1, and may be 3 or more, because a capability of forming a protective film is improved, and a firmer and stabler protective film is formed accordingly.

Examples of the halogenated cyclic ester carbonate include compounds represented by the following expressions (6-1) to (6-21), and the halogenated cyclic ester carbonate also includes a geometric isomer. In particular, 4-fluoro-1,3-dioxolane-2-one represented by the expression (6-1) and 4,5-difluoro-1,3-dioxolane-2-one represented by the expression (6-3) are preferable, and the latter carbonate is more preferable. Moreover, as 4,5-difluoro-1,3-dioxolane-2-one, a trans-isomer is more preferable than a cis-isomer, because it is easily available, and a high effect is obtainable. Examples of the halogenated chain ester carbonate include fluoromethyl methyl carbonate, bis(fluoromethyl) carbonate, and difluoromethyl methyl carbonate.

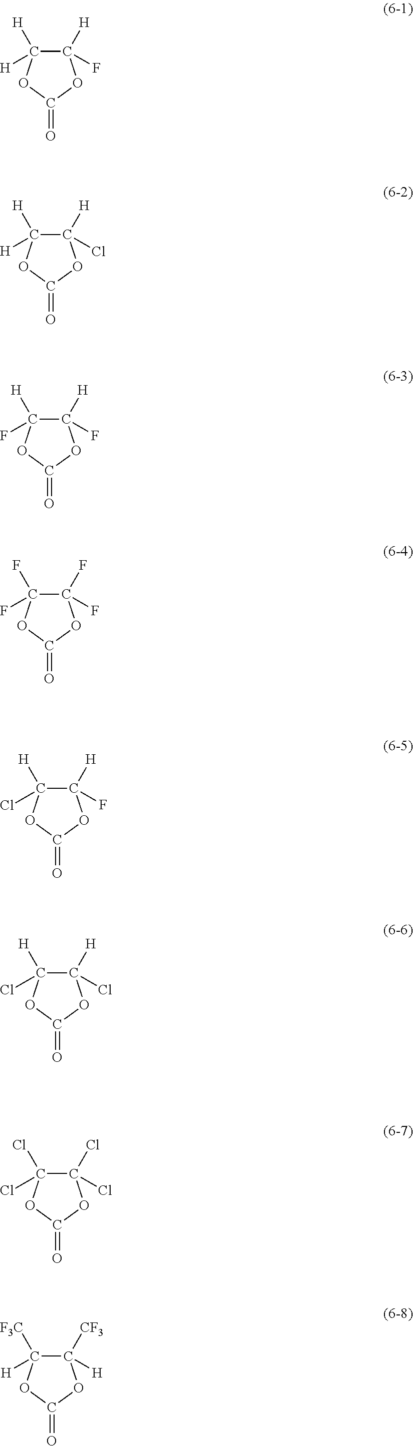

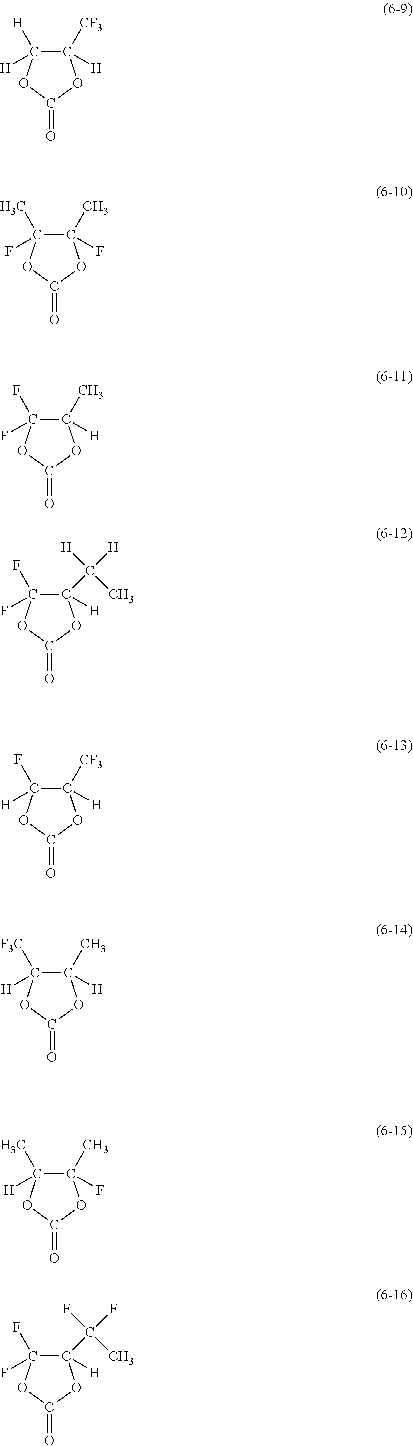

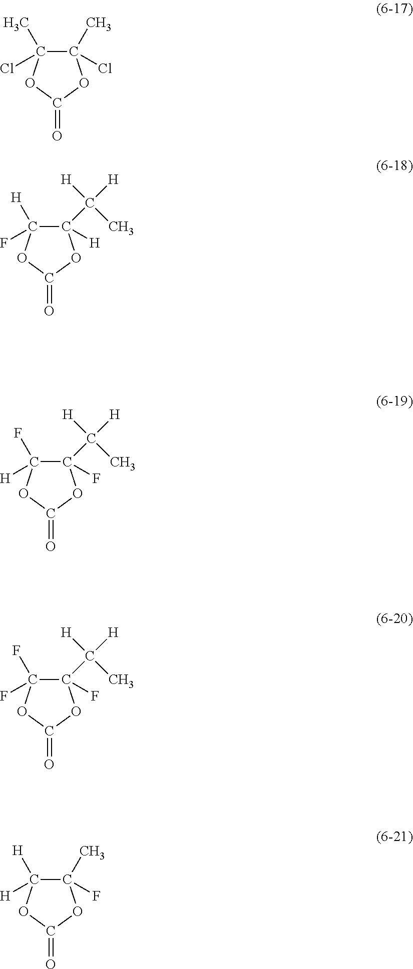

Moreover, the solvent preferably includes a sultone (a cyclic sulfonate ester), because chemical stability of the electrolytic solution is further improved. Examples of the sultone include propane sultone and propene sultone. The content of the sultone in the solvent is not specifically limited, but is, for example, within a range of 0.5 wt % to 5 wt %, both inclusive. It is to be noted that specific examples of the sultone are not limited to the above-described compounds.

Further, the solvent preferably includes an acid anhydride, because chemical stability of the electrolytic solution is further improved. Examples of the acid anhydride include a carboxylic anhydride, a disulfonic anhydride, and an anhydride of a carboxylic acid and a sulfonic acid. Examples of the carboxylic anhydride include succinic anhydride, glutaric anhydride, and maleic anhydride. Examples of the disulfonic anhydride include ethanedisulfonic anhydride and propanedisulfonic anhydride. Examples of the anhydride of a carboxylic acid and a sulfonic acid include sulfobenzoic anhydride, sulfopropionic anhydride, and sulfobutyric anhydride. It is to be noted that the content of the acid anhydride in the solvent is not specifically limited, but is, for example, within a range of 0.5 wt % to 5 wt % both inclusive. Specific examples of the acid anhydride are not limited to the above-described compounds.

The electrolyte salt used in the electrolytic solution includes, for example, one or more kinds of salts such as lithium salt. The electrolyte salt may include, for example, any salt other than lithium salt (for example, a light-metal salt other than lithium salt).

Examples of the lithium salt include lithium hexafluorophosphate (LiPF₆), lithium tetrafluoroborate (LiBF₄), lithium perchlorate (LiClO₄), lithium hexafluoroarsenate (LiAsF₆), lithium tetraphenyl borate (LiB(C₆H₅)₄), lithium methanesulfonate (LiCH₃SO₃), lithium trifluoromethane sulfonate (LiCF₃SO₃), lithium tetrachloroaluminate (LiAlCl₄), lithium silicate hexafluoride (Li₂SiF₆), lithium chloride (LiCl), and lithium bromide (LiBr), because superior battery capacity, superior cycle characteristics, superior storage characteristics, and the like are obtainable. Specific examples of lithium salt are not limited to the above-described compounds.

In particular, one or more kinds selected from a group configured of LiPF₆, LiBF₄, LiClO₄, and LiAsF₆ are preferable, and LiPF₆ is more preferable, because internal resistance is reduced, and a higher effect is obtainable accordingly.

In particular, the electrolyte salt preferably includes one or more kinds selected from compounds represented by the following expressions (8) to (10), because a higher effect is obtainable. It is to be noted that the kinds of R31 and R33 may be the same as or different from each other. The same applies to R41 to R43, and R51 and R52. However, specific examples of the compounds represented by the expressions (8) to (10) are not limited to compounds which will be described below.

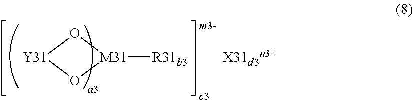

where X31 is a Group 1 element or a Group 2 element in the long form of the periodic table of the elements, or A1, M31 is a transition metal element, or a Group 13 element, a Group 14 element, or a Group 15 element in the long form of the periodic table of the elements, R31 is a halogen group, Y31 is —C(═O)—R32-C(═O)—, —C(═O)—CR33₂-, or —C(═O)—C(═O)—, in which R32 is an alkylene group, a halogenated alkylene group, an arylene group, or a halogenated arylene group, R33 is an alkyl group, a halogenated alkyl group, an aryl group, or a halogenated aryl group, a3 is an integer of 1 to 4, b3 is an integer of 0, 2, or 4, and c3, d3, m3, and n3 each are an integer of 1 to 3.

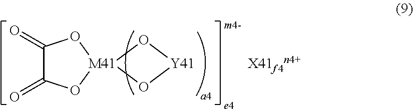

where X41 is a Group 1 element or a Group 2 element in the long form of the periodic table of the elements, M41 is a transition metal element, or a Group 13 element, a Group 14 element, or a Group 15 element in the long form of the periodic table of the elements, Y41 is —C(═O)—(CR41₂)_{b4}-C(═O)—, —R43₂C—(CR42₂)_{c4}-C(═O)—, —R43₂C—(CR42₂)_{c4}—CR43₂-, —R43₂C—(CR42₂)_{c4}-S(═O)₂—, —S(═O)₂—(CR42₂)_{d4}-S(═O)₂—, or —C(═O)—(CR42₂)_{d4}-S(═O)₂—, in which R41 and R43 each are a hydrogen group, an alkyl group, a halogen group, or a halogenated alkyl group, and one or both of them are a halogen group or a halogenated alkyl group, R42 is a hydrogen group, an alkyl group, a halogen group, or a halogenated alkyl group, a4, e4, and n4 each are an integer of 1 or 2, b4 and d4 each are an integer of 1 to 4, c4 is an integer of 0 to 4, and f4 and m4 each are an integer of 1 to 3.

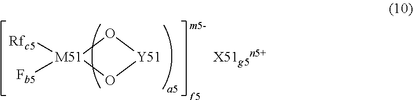

where X51 is a Group 1 element or a Group 2 element in the long form of the periodic table of the elements, M51 is a transition metal element, or a Group 13 element, a Group 14 element, or a Group 15 element in the long form of the periodic table of the elements, Rf is a fluorinated alkyl group having 1 to 10 carbon atoms or a fluorinated aryl group having 1 to 10 carbon atoms, Y51 is —C(═O)—(CR51₂)_{d5}-C(═O), —R52₂C—(CR51₂)_{d5}-C(═O)—, —R52₂C—(CR51₂)_{d5}-CR52₂-, —R52₂C—(CR51₂)_{d5}-S(═O)₂—, —S(═O)₂—(CR51₂)ₑ₅-S(═O)₂—, or —C(═O)—(CR51₂)ₑ₅—S(═O)₂—, in which R51 is a hydrogen group, an alkyl group, a halogen group, or a halogenated alkyl group, R52 is a hydrogen group, an alkyl group, a halogen group, or a halogenated alkyl group, one or more of them are a halogen group or a halogenated alkyl group, a5, f5, and n5 each are an integer of 1 or 2, b5, c5, and e5 each are an integer of 1 to 4, d5 is an integer of 0 to 4, and g5 and m5 each are an integer of 1 to 3.

It is to be noted that Group 1 elements include H, Li, Na, K, Rb, Cs, and Fr. Group 2 elements include Be, Mg, Ca, Sr, Ba, and Ra. Group 13 elements include B, Al, Ga, In, and Tl. Group 14 elements include C, Si, Ge, Sn, and Pb. Group 15 elements include N, P, As, Sb, and Bi.

Examples of the compound represented by the expression (8) include compounds represented by expressions (8-1) to (8-6). Examples of the compound represented by the expression (9) include compounds represented by expressions (9-1) to (9-8). Examples of the compound represented by the expression (10) include a compound represented by an expression (10-1).

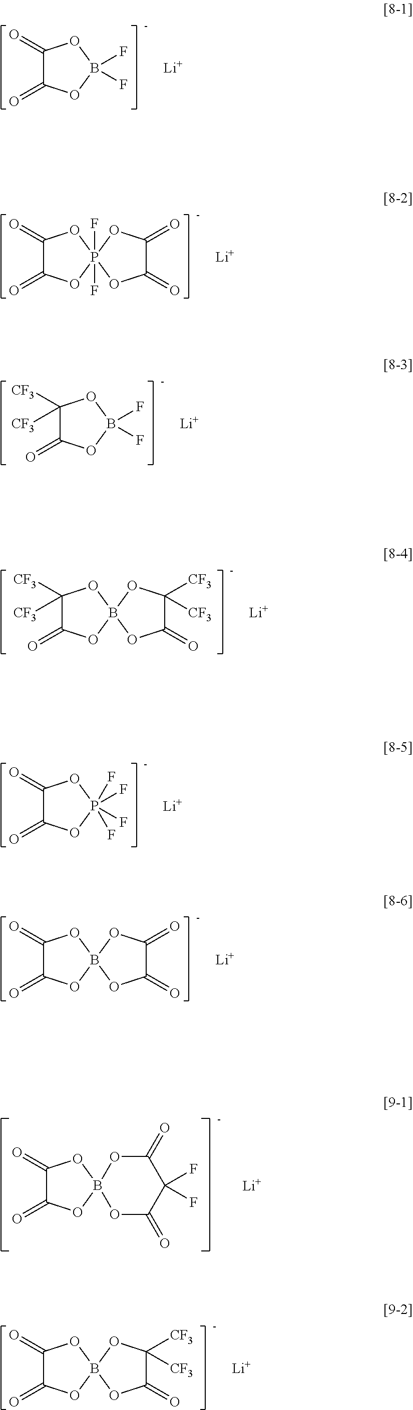

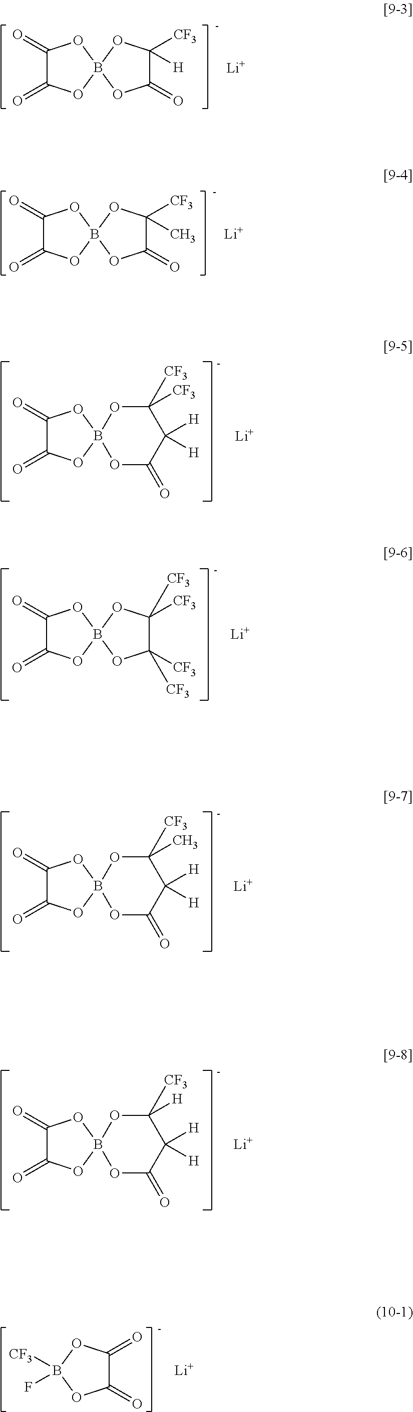

Moreover, the electrolyte salt preferably includes one or more kinds selected from compounds represented by the following expressions (11) to (13), because a higher effect is obtainable. It is to be noted that the values of m and n may be the same as or different from each other. The same applies to p, q, and r. However, specific examples of the compounds represented by the expressions (11) to (13) are not limited to compounds which will be described below.

LiN(CₘF₂ₘ₊₁SO₂)(CₙF₂ₙ₊₁SO₂) (11)

where m and n each are an integer of 1 or more.

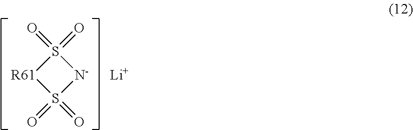

where R61 is a straight-chain or branched perfluoroalkylene group having 2 to 4 carbon atoms.

LiC(CₚF₂ₚ₊₁SO₂)(C_{q}F_{2q+1}SO₂)(CᵣF₂ᵣ₊₁SO₂) (13)

where p, q, and r each are an integer of 1 or more.

The compound represented by the expression (11) is a chain imide compound, and examples thereof include lithium bis(trifluoromethane-sulfonyl)imide (LiN(CF₃SO₂)₂), lithium bis(pentafluoroethanesulfonyl)imide (LiN(C₂F₅SO₂)₂)/lithium (trifluoromethanesulfonyl)(pentafluoroethanesulfonyl)imide (LiN(CF₃SO₂)(C₂F₅SO₂)), lithium (trifluoromethanesulfonyl)(heptafluoropropanesulfonyl)imide (LiN(CF₃SO₂)(C₃F₇SO₂)), and lithium (trifluoromethanesulfonyl)(nonafluorobutanesulfonyl)imide (LiN(CF₃SO₂)(C₄F₉SO₂)).

The compound represented by the expression (12) is a cyclic imide compound, and examples thereof include compounds represented by expressions (12-1) to (12-4).

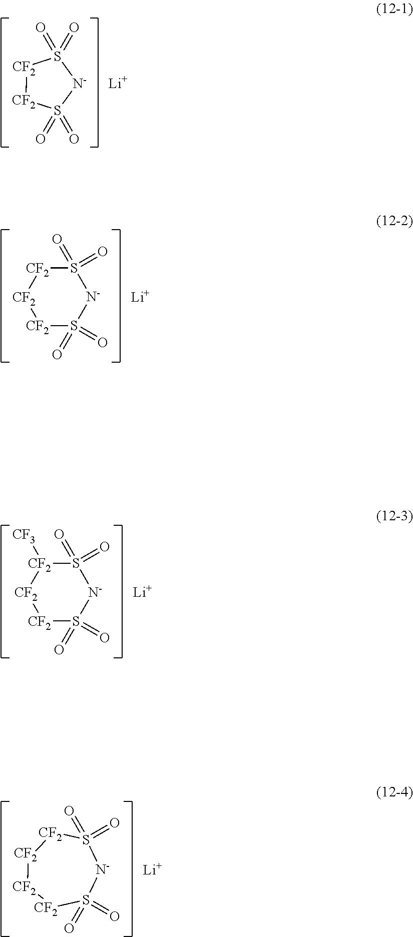

The compound represented by the expression (13) is a chain methide compound, and examples thereof include lithium tris(trifluoromethanesulfonyl)methide (LiC(CF₃SO₂)₃).

The content of the electrolyte salt is not specifically limited, but is preferably within a range from 0.3 mol/kg to 3.0 mol/kg both inclusive relative to the solvent, because high ionic conductivity is obtainable.

[Operation of Secondary Battery]

In the secondary battery, for example, lithium ions extracted from the cathode 21 are inserted into the anode 22 through the electrolytic solution during charge, and lithium ions extracted from the anode 22 are inserted into the cathode 21 through the electrolytic solution during discharge.

At this time, the open-circuit voltage under a fully-charged state per pair of the cathode 21 and the anode 22 is set to 4.3 V or over through adjusting the amount of the cathode active material and the amount of the anode active material. Compared to the case where the open-circuit voltage is smaller than 4.3 V, even if an anode active material of a same kind is used, the amount of extraction of lithium ions per unit mass is increased; therefore, higher energy density is obtained. The “open-circuit voltage under a fully-charged state” is a potential of the cathode 21 (a battery voltage) under a fully-charged state, and means a so-called upper limit of a charge voltage.

[Method of Manufacturing Secondary Battery]

The secondary battery is manufactured by, for example, the following steps.

First of all, the cathode 21 is formed. The cathode active material and, if necessary, the cathode binder, the cathode conductor, and the like are mixed to form a cathode mixture. Then, the cathode mixture is dispersed in an organic solvent or the like to form paste-form cathode mixture slurry. Next, both surfaces of the cathode current collector 21A are coated with the cathode mixture slurry, and the cathode mixture slurry is dried to form the cathode active material layer 21B. In this case, the cathode active material layer 21B may be formed on only one surface of the cathode current collector 21A. Then, the cathode active material layer 21B is compression molded by a roller press or the like while applying heat, if necessary. In this case, compression molding may be repeated a plurality of times.

Moreover, the anode 22 is formed by steps similar to the above-described steps of forming the cathode 21. An anode mixture is formed through mixing the anode active material and, if necessary, the anode binder, the anode conductor, and the like, and the anode mixture is dispersed in an organic solvent or the like to form paste-form anode mixture slurry. Next, one surface or both surfaces of the anode current collector 22A are coated with the anode mixture slurry, and the anode mixture slurry is dried to form the anode active material layer 22B. Then, if necessary, the anode active material layer 22B is compression molded.

Further, the electrolyte salt is dispersed in the solvent, and then the unsaturated cyclic ester carbonate is added to the solvent to prepare the electrolytic solution.

Finally, the secondary battery is assembled with use of the cathode 21 and the anode 22. The cathode lead 25 and the anode lead 26 are attached to the cathode current collector 21A and the anode current collector 22A, respectively, by a welding method or the like. Then, the cathode 21 and the anode 22 are laminated with the separator 23 in between, and they are spirally wound to form the spirally wound electrode body 20, and then the center pin 24 is inserted into the center of the spirally wound electrode body 20. Next, the spirally wound electrode body 20 sandwiched between the pair of insulating plate 12 and 13 is contained in the battery can 11. In this case, an end of the cathode lead 25 and an end of the anode lead 26 are attached to the safety valve mechanism 15 and the battery can 11, respectively, by a welding method or the like. Then, the electrolytic solution is injected into the battery can 11 to impregnate the separator 23 with the electrolytic solution. Next, the battery cover 14, the safety valve mechanism 15, and the PTC device 16 are caulked in an open end of the battery can 11 by the gasket 17.

[Functions and Effects of Secondary Battery]

In the cylindrical type secondary battery, the open-circuit voltage under a fully-charged state per pair of the cathode 21 and the anode 22 is 4.3 V or over, and the electrolytic solution includes the unsaturated cyclic ester carbonate. In this case, as described above, even if the upper limit of the charge voltage is high, chemical stability of the electrolytic solution is maintained; therefore, high battery capacity is obtained, and decomposition reaction of the electrolytic solution is suppressed. Accordingly, superior battery characteristics are obtainable.

In particular, when the content of the unsaturated cyclic ester carbonate in the electrolytic solution is within a range of 0.01 wt % to 10 wt % both inclusive, a higher effect is obtainable. Moreover, when the unsaturated cyclic ester carbonate is any one of the compounds represented by the expressions (1-1) to (1-56), more specifically, when the unsaturated cyclic ester carbonate is the compound presented by the expression (2) or (3), a higher effect is obtainable. In addition, when the cathode 21 includes the lithium-rich compound represented by the expression (21), a higher effect is obtainable. Further, when the thickness of the cathode active material layer 21B is about 40 μm or over, or the thickness of the anode active material layer 22B is about 20 μm or over, a higher effect is obtainable.

(1-2. Laminate Film Type)

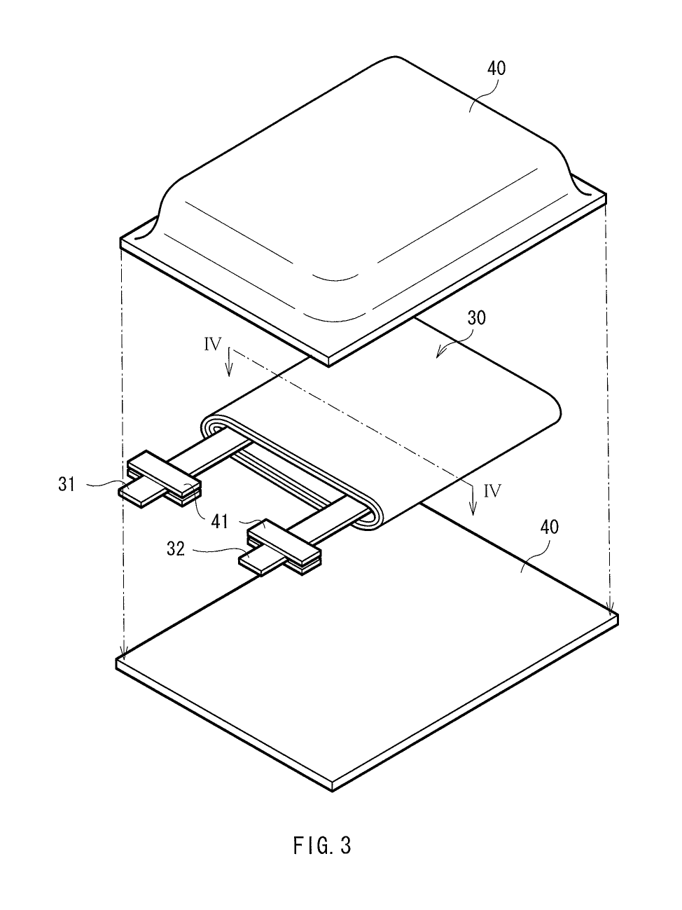

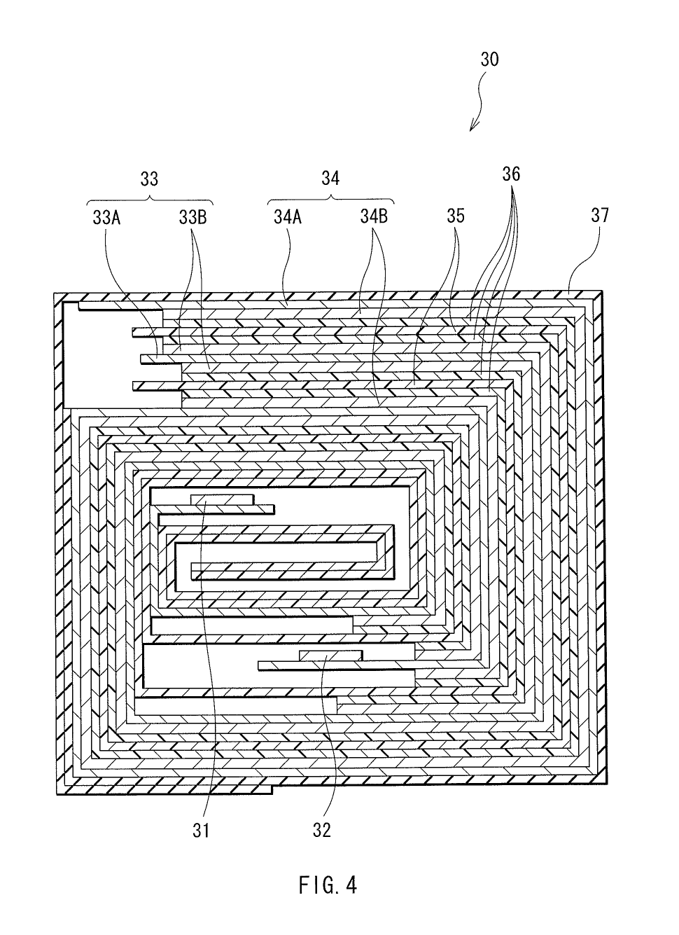

FIG. 3 illustrates an exploded perspective configuration of another secondary battery according to the embodiment of the application, and FIG. 4 illustrates an enlarged sectional view taken along a line IV-IV of a spirally wound electrode body 30 illustrated in FIG. 3. A description will be given of constituent components of the secondary battery with reference to the above-described components of the cylindrical type secondary battery as appropriate.

[Entire Configuration of Secondary Battery]

The secondary battery described herein is a so-called laminate film type lithium ion secondary battery. In the secondary battery, the spirally wound electrode body 30 is contained in film-shaped package members 40, and the spirally wound electrode body 30 is formed through laminating a cathode 33 and an anode 34 with a separator 35 and an electrolyte layer 36 in between, and spirally winding them. A cathode lead 31 and an anode lead 32 are attached to the cathode 33 and the anode 34, respectively. An outermost portion of the spirally wound electrode body 30 is protected with a protective tape 37.

The cathode lead 31 and the anode lead 32 are drawn, for example, from the interiors of the package members 40 to outside in the same direction. The cathode lead 31 is made of, for example, a conductive material such as aluminum, and the anode lead 32 is made of, for example, a conductive material such as copper, nickel, or stainless. These conductive materials each have a sheet shape or a mesh shape.

The package members 40 are laminate films formed through laminating, for example, a bonding layer, a metal layer, and a surface protection layer in this order. In the laminate films, for example, edge portions of the bonding layers of two laminate films are adhered to each other by fusion bonding to allow the bonding layers to face the spirally wound electrode body 30. The two laminate films may be adhered to each other by an adhesive. The bonding layer is, for example, a film of polyethylene or polypropylene. The metal layer is, for example, aluminum foil. The surface protection layer is, for example, a film of nylon or polyethylene terephthalate.

In particular, as the package members 40, aluminum laminate films each formed through laminating a polyethylene film, aluminum foil, and a nylon film in this order are preferable. However, the package members 40 may be laminate films with any other laminate configuration, polymer films of polypropylene or the like, or metal films.

Adhesive films 41 for preventing the entry of outside air are inserted between each package member 40 and the cathode lead 31 and between each package member 40 and the anode lead 32. The adhesive films 41 are made of, for example, a material having adhesion to the cathode lead 31 and the anode lead 32. Examples of the material having adhesion include polyolefin resins such as polyethylene, polypropylene, modified polyethylene, and modified polypropylene.

The cathode 33 includes, for example, a cathode active material layer 33B on one surface or both surfaces of a cathode current collector 33A. The anode 34 includes, for example, an anode active material layer 34B on one surface or both surfaces of an anode current collector 34A. The configurations of the cathode current collector 33A, the cathode active material layer 33B, the anode current collector 34A, and the anode active material layer 34B are similar to those of the cathode current collector 21A, the cathode active material layer 21B, the anode current collector 22A, and the anode active material layer 22B, respectively. Moreover, the configuration of the separator 35 is similar to that of the separator 23.

The electrolyte layer 36 is formed through holding an electrolytic solution by a polymer compound, and is a so-called gel electrolyte, because high ionic conductivity (for example, 1 mS/cm or over at room temperature) is obtainable, and leakage of the electrolytic solution is prevented. The electrolyte layer 36 may include any other material such as an additive, if necessary.

The polymer compound is, for example, one or more kinds selected from a group configured of polyacrylonitrile, polyvinylidene fluoride, polytetrafluoroethylene, polyhexafluoropropylene, polyethylene oxide, polypropylene oxide, polyphosphazene, polysiloxane, polyvinyl fluoride, polyvinyl acetate, polyvinyl alcohol, poly(methyl methacrylate), polyacrylic acids, polymethacrylic acids, styrene-butadiene rubber, nitrile-butadiene rubber, polystyrene, polycarbonate, a copolymer of vinylidene fluoride and hexafluoropyrene, and the like. In particular, polyvinylidene fluoride or the copolymer of vinylidene fluoride and hexafluoropyrene is preferable, and polyvinylidene fluoride is more preferable, because they are electrochemically stable.

The composition of the electrolytic solution is similar to that in the cylindrical type secondary battery, and the electrolytic solution includes the unsaturated cyclic ester carbonate. However, in the electrolyte layer 36 which is a gel electrolyte, the solvent of the electrolytic solution refers to a wide concept including not only a liquid solvent but also a material having ionic conductivity which is capable of dissociating an electrolyte salt. Therefore, in the case where a polymer compound having ionic conductivity is used, the polymer compound is included in the concept of the solvent.

It is to be noted that, instead of the gel electrolyte layer 36, the electrolytic solution may be used as it is. In this case, the separator 35 may be impregnated with the electrolytic solution.

[Operation of Secondary Battery]

In the secondary battery, for example, lithium ions extracted from the cathode 33 are inserted into the anode 34 through the electrolyte layer 36 during charge, and, for example, lithium ions extracted from the anode 34 are inserted into the cathode 33 through the electrolyte layer 36 during discharge. As in the case of the cylindrical type secondary battery, to obtain high energy density, an open-circuit voltage (an upper limit of a charge voltage under a fully-charged state per pair of the cathode 33 and the anode 34 is set to 4.3 V or over.

[Method of Manufacturing Secondary Battery]

The secondary battery including the gel electrolyte layer 36 is manufactured by, for example, the following three kinds of methods.

In a first method, first, by steps similar to the above-described steps of forming the cathode 21 and the anode 22, the cathode 33 and the anode 34 are formed. In this case, the cathode active material layer 33B is formed on one surface or both surfaces of the cathode current collector 33A to form the cathode 33, and the anode active material layer 34B is formed on one surface or both surfaces of the anode current collector 34A to form the anode 34. Next, a precursor solution including the electrolytic solution, the polymer compound, the organic solvent, and the like is prepared, and then the cathode 33 and the anode 34 are coated with the precursor solution to form the gel electrolyte layer 36. Next, the cathode lead 31 and the anode lead 32 are attached to the cathode current collector 33A and the anode current collector 34A, respectively, by a welding method or the like. Then, the cathode 33 and the anode 34 are laminated and spirally wound with the separator 35 in between to form the spirally wound electrode body 30, and then the protective tape 37 is bonded to an outermost portion of the spirally wound electrode body 30. Next, the spirally wound electrode body 30 is sandwiched between two film-shaped package members 40, and edge portions of the package members 40 are adhered to each other by a thermal fusion bonding method or the like to seal the spirally wound electrode body 30 in the package members 40. In this case, the adhesive films 41 are inserted between the cathode lead 31 and each package member 40 and between the anode lead 32 and each package member 40.

In a second method, first, the cathode lead 31 and the anode lead 32 are attached to the cathode 33 and the anode 34, respectively. Next, the cathode 33 and the anode 34 are laminated and spirally wound with the separator 35 in between to form a spirally wound body as a precursor body of the spirally wound electrode body 30, and then the protective tape 37 is bonded to an outermost portion of the spirally wound body. Then, the spirally wound body is sandwiched between two film-shaped package members 40, and the edge portions of the package members 40 except for edge portions on one side are adhered by a thermal fusion bonding method or the like to contain the spirally wound body in the package members 40 configuring a pouched package. Next, an electrolytic composition which includes the electrolytic solution, monomers as materials of a polymer compound, and a polymerization initiator, and, if necessary, any other material such as a polymerization inhibitor is prepared, and is injected into the package members 40 configuring the pouched package, and then an opened portion of the pouched package configured of the package members 40 is sealed by a thermal fusion bonding method or the like. Then, the monomers are thermally polymerized to form the polymer compound, thereby forming the gel electrolyte layer 36.

In a third method, as in the case of the above-described second method, the spirally wound body is formed, and the spirally wound body is contained in the package members 40 configuring the pouched package, except that the separator 35 having both surfaces coated with a polymer compound is used. Examples of the polymer compound applied to the separator 35 include polymers (a homopolymer, a copolymer, and a multicomponent copolymer) including vinylidene fluoride as a component. More specifically, examples of the polymer compound include polyvinylidene fluoride, a binary copolymer including vinylidene fluoride and hexafluoropropylene as components, and a ternary copolymer including vinylidene fluoride, hexafluoropropylene, and chlorotrifluoroethylene as components. It is to be noted that one or more kinds of other polymer compounds may be used together with the polymer including vinylidene fluoride as a component. Next, the electrolytic solution is prepared, and is injected into the package members 40, and then an opened portion of a pouched package configured of the package members 40 is sealed by a thermal fusion bonding method or the like. Next, the package members 40 are heated while being weighted to bring the separator 35 into close contact with the cathode 33 and the anode 34 with the polymer compound in between. The polymer compound is thereby impregnated with the electrolytic solution, and the polymer compound is gelatinized to form the electrolyte layer 36.

In the third method, compared to the first method, swelling of the secondary battery is further suppressed. Moreover, in the third method, compared to the second method, monomers as the materials of the polymer compound, the solvent, and the like hardly remain in the electrolyte layer 36, thereby better controlling a step of forming the polymer compound. Therefore, sufficient adhesion between each of the cathode 33, the anode 34 and the separator 35, and the electrolyte layer 36 is obtained.

[Functions and Effects of Secondary Battery]

In the laminate film type secondary battery, the open-circuit voltage under a fully-charged state per pair of the cathode 33 and the anode 34 is 4.3 V or over, and the electrolytic solution in the electrolyte layer 36 includes the unsaturated cyclic ester carbonate. Therefore, superior battery characteristics are obtained by a reason similar to that in the case of the cylindrical type secondary battery. Functions and effects other than this are similar to those in the cylindrical type secondary battery.

(2. Applications of Secondary Batteries)

Next, application examples of any of the above-described secondary batteries will be described below.

The application of any of the secondary batteries is not specifically limited, as long as any of the secondary batteries is applied to machines, devices, appliances, units, systems (combinations of a plurality of devices), and the like which each are allowed to use any of the secondary batteries as a power supply for drive or a power storage source for power storage. In the case where any of the secondary batteries is used as a power supply, the power supply may be a main power supply (a power supply to be preferentially used) or an auxiliary power supply (a power supply to be used instead of the main power supply or by switching from the main power supply). The kind of the main power supply in the latter case is not limited to secondary batteries.

The secondary batteries are applied to, for example, the following applications. The applications include electronic units (including portable electronic units) such as video cameras, digital still cameras, cellular phones, notebook personal computers, cordless telephones, headphone stereos, portable radios, portable televisions, and personal digital assistants. The applications further include portable home appliances such as electric shavers, memory units such as backup power supplies and memory cards, electric power tools such as electric drills and electric saws, battery packs used as power supplies of notebook personal computers, medical electronic units such as pacemakers and hearing aids, electric vehicles such as electric cars (including hybrid vehicles), and electric energy storage system such as household battery systems storing power in case of emergency or the like. The secondary batteries may be applied to any applications other than the above-described applications.

In particular, the secondary batteries are effectively applied to the battery packs, the electric vehicles, the electric energy storage systems, the electric power tools, the electronic units, and the like, because they need superior battery characteristics, and their performance is effectively improved through using any of the secondary batteries according to the embodiment of the application. It is to be noted that the battery packs are power supplies using any of the secondary batteries, and are so-called assembled batteries or the like. The electric vehicles are vehicles operating (running) with use of any of the secondary batteries as a power supply for drive, and as described above, the electric vehicles may include vehicles (such as hybrid vehicles) including a driving source in addition to the secondary battery. The electric energy storage systems are systems using any of the secondary batteries as a power storage source. For example, in a household electric energy storage system, power is stored in any of the secondary batteries as a power storage source, and the power is consumed when necessary to allow home appliances or the like to be used by the household electric energy storage system. The electric power tools are tools having a movable section (such as a drill) which is movable with use of any of the secondary batteries as a power supply for drive. The electronic units are unit fulfilling various functions with use of any of the secondary batteries as a power supply for drive.

Some application examples of the secondary batteries will be described in detail below. It is to be noted that the configurations of the application examples which will be described below are just examples, and may be modified, as necessary.

(2-1. Battery Pack)

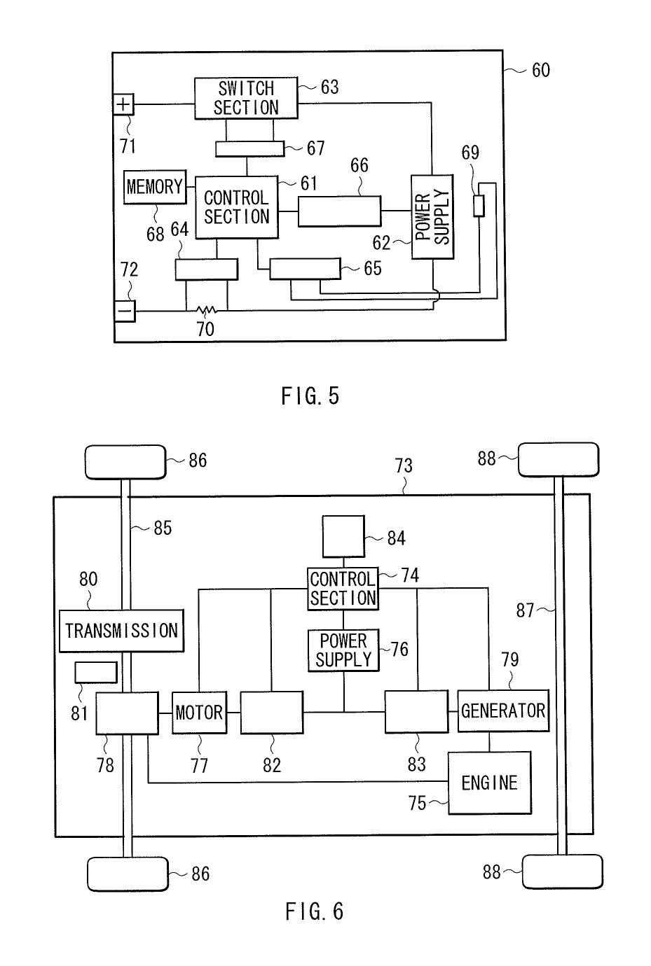

FIG. 5 illustrates a block configuration of a battery pack. For example, the battery pack includes a control section 61, a power supply 62, a switch section 63, a current measurement section 64, a temperature detection section 65, a voltage detection section 66, a switch control section 67, a memory 68, a temperature detection device 69, a current sensing resistor 70, a cathode terminal 71, and an anode terminal 72 in an enclosure 60 made of a plastic material or the like.

The control section 61 controls operation of the entire battery pack (including a usage state of the power supply 62), and includes, for example, a central processing unit (CPU). The power supply 62 includes one or two or more secondary batteries (not illustrated). The power supply 62 is, for example, an assembled battery including two or more secondary batteries, and the secondary batteries may be connected to one another in series, in parallel, or in any series-parallel combination. As an example, the power supply 62 includes six secondary batteries connected in a configuration of two in parallel by three in series.

The switch section 63 switches the usage state of the power supply 62 (connection and disconnection between the power supply 62 and an external unit) according to an instruction from the control section 61. The switch section 63 includes, for example, a charge control switch, a discharge control switch, a diode for charge, and a diode for discharge (all not illustrated). The charge control switch and the discharge control switch are, for example, semiconductor switches such as metal oxide semiconductor field-effect transistors (MOSFETs) using a metal oxide semiconductor.

The current measurement section 64 measures a current with use of the current sensing resistor 70, and outputs a measurement result to the control section 61. The temperature detection section 65 measures a temperature with use of the temperature detection device 69, and outputs a measurement result to the control section 61. The temperature measurement result is used, for example, in the case where the control section 61 performs charge-discharge control during abnormal heat generation or in the case where the control section 61 performs a correction process during calculation of a remaining capacity level. The voltage detection section 66 measures the voltage of each of the secondary batteries in the power supply 62, and performs analog-to-digital (A/D) conversion on the measured voltage to supply the voltage to the control section 61.

The switch control section 67 controls the operation of the switch section 63 based on signals supplied from the current measurement section 64 and the voltage detection section 66.

For example, when a battery voltage reaches an overcharge detection voltage, the switch control section 67 turns off the switch section 63 (the charge control switch) to control a charge current not to flow through a current path of the power supply 62. Thus, in the power supply 62, only discharge through the diode for discharge is allowed to be executed. It is to be noted that, for example, when a large current flows during charge, the switch control section 67 blocks a charge current.

Moreover, for example, when the battery voltage reaches an overdischarge detection voltage, the switch control section 67 turns off the switch section 63 (the discharge control switch) to control a discharge current not to flow through the current path of the power supply 62. Thus, in the power supply 62, only charge through the diode for charge is allowed to be executed. It is to be noted that, for example, when a large current flows during discharge, the switch control section 67 blocks a discharge current.

It is to be noted that, in the secondary battery, for example, the overcharge detection voltage is 4.20 V±0.05 V, and the overdischarge detection voltage is 2.4 V±0.1 V.

The memory 68 is, for example, an EEPROM which is a non-volatile memory, or the like. In the memory 68, for example, values computed by the control section 61, and information (for example, initial internal resistance) of the secondary batteries measured in a manufacturing process are stored. It is to be noted that, when the value of full-charge capacity of each of the secondary batteries is stored in the memory 68, the control section 61 is allowed to keep track of information such as the remaining capacity level.

The temperature detection device 69 measures the temperature of the power supply 62, and outputs a measurement result to the control section 61, and is, for example, a thermistor.

The cathode terminal 71 and the anode terminal 72 are terminals connected to an external unit (such as a notebook personal computer) operating by the battery pack or an external unit (such as a charger) used to charge the battery pack. The power supply 62 is charged and discharged through the cathode terminal 71 and the anode terminal 72.

(2-2. Electric Vehicle)

FIG. 6 illustrates a block configuration of a hybrid vehicle as an example of the electric vehicle. For example, the electric vehicle includes a control section 74, an engine 75, a power supply 76, a drive motor 77, a differential gear 78, a generator 79, a transmission 80, and a clutch 81, inverters 82 and 83, and various sensors 84 in a body 73 made of metal. The electric vehicle further includes, for example, a front-wheel axle 85 and front wheels 86 which are connected to the differential gear 78 and the transmission 80, and a rear-wheel axle 87 and rear wheels 88.

The electric vehicle is capable of running with use of one of the engine 75 and the motor 77 as a driving source. The engine 75 is a main power source, and is, for example, a gasoline engine or the like. When the engine 75 is used as a power source, for example, the driving force (torque) of the engine 75 is transmitted to the front wheels 86 or the rear wheels 88 through drive sections, i.e., the differential gear 78, the transmission 80, and the clutch 81. It is to be noted that the torque of the engine 75 is also transmitted to the generator 79 to allow the generator 79 to generate AC power by the torque, and the AC power is converted into DC power by the inverter 83 to be stored in the power supply 76. On the other hand, in the case where the motor 77 as a conversion section is used as a power source, power (DC power) supplied from the power supply 76 is converted into AC power by the inverter 82, and the motor 77 is driven by the AC power. For example, the driving force (torque) into which the power is converted by the motor 77 is transmitted to the front wheels 86 or the rear wheels 88 through the drive sections, i.e., the differential gear 78, the transmission 80, and the clutch 81.

It is to be noted that when the electric vehicle is slowed down by a braking mechanism (not illustrated), resistance while slowing the electric vehicle down may be transmitted to the motor 77 as a torque to allow the motor 77 to generate AC power by the torque. The AC power is preferably converted into DC power by the inverter 82 to store DC regenerative power in the power supply 76.

The control section 74 controls operation of the entire electric vehicle, and includes, for example, a CPU. The power supply 76 includes one or more secondary batteries (not illustrated). The power supply 76 may be connected to an external power supply to receive power from the external power supply; therefore, the power supply 76 is allowed to store power. The various sensors 84 are used to control the RPM of the engine 75 or opening of a throttle valve (throttle opening; not illustrated). The various sensors 84 include, for example, a speed sensor, an acceleration sensor, and an engine RPM sensor.

It is to be noted that the hybrid vehicle is described above as the electric vehicle; however, the electric vehicle may be a vehicle (electric car) driven only by the power supply 76 and the motor 77 without using the engine 75.

(2-3. Electric Energy Storage System)

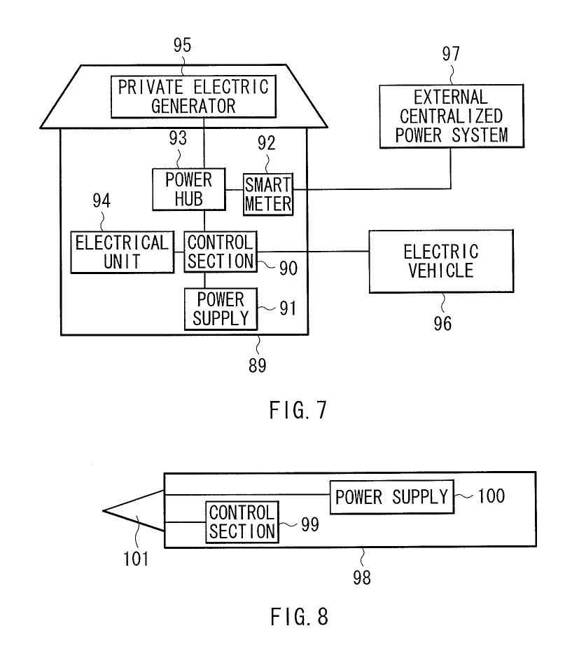

FIG. 7 illustrates a block configuration of an electric energy storage system. For example, the electric energy storage system includes a control section 90, a power supply 91, a smart meter 92, and a power hub 93 in a house 89 such as a general house or a commercial building.

In this case, for example, the power supply 91 is connected to an electrical unit 94 placed in the house 89, and is connectable to an electric vehicle 96 placed outside the house 89. Moreover, for example, the power supply 91 is connected to a private electric generator 95 mounted on the house 89 through the power hub 93, and is connectable to an external centralized power system 97 through the smart meter 92 and the power hub 93.

It is to be noted that examples of the electrical unit 94 include one or more household electrical appliances such as a refrigerator, an air conditioner, a television, and a boiler. Examples of the private electric generator 95 include one or more kinds of solar power systems or wind power generators. Examples of the electric vehicle 96 include one or more kinds of electric vehicles, electric motorbikes, and hybrid vehicles. Examples of the centralized power system 97 include one or more kinds of thermal power plants, nuclear power plants, hydroelectric power plants, and wind power plants.

The control section 90 controls operation of the entire electric energy storage system (including a usage state of the power supply 91), and includes, for example, a CPU. The power supply 91 includes one or more secondary batteries (not illustrated). The smart meter 92 is a network-compatible wattmeter mounted in the house 89 demanding power, and is allowed to communicate with a power supplier. Accordingly, for example, the smart meter 92 controls balance between demand and supply in the house 89 while communicating with an external unit as necessary, thereby securing efficient and stable energy supply.

In the electric energy storage system, for example, power from the centralized power system 97 as the external power supply is stored in the power supply 91 through the smart meter 92 and the power hub 93, and power from the private electric generator 95 as an independent power supply is stored in the power supply 91 through the power hub 93. The power stored in the power supply 91 is supplied to the electrical unit 94 or the electric vehicle 96 as necessary according to an instruction from the control section 90; therefore, the electrical unit 94 is operable, and the electric vehicle 96 is allowed to be charged. In other words, the electric energy storage system is a system capable of storing and supplying power in the house 89 with use of the power supply 91.

The power stored in the power supply 91 is arbitrarily usable. Therefore, for example, the power from the centralized power system 97 is allowed to be stored in the power supply 91 at midnight at which a power rate is low, and the power stored in the power supply 91 is allowed to be used in the daytime in which the power rate is high.

It is to be noted that the above-described electric energy storage system may be mounted per house (per household), or per a plurality of houses (a plurality of households).

(2-4. Electric Power Tool)

FIG. 8 illustrates a block configuration of an electric power tool. For example, the electric power tool is an electric drill, and includes a control section 99 and a power supply 100 in a tool body 98 formed of a plastic material or the like. A drill section 101 as a movable section is operably (rotatably) attached to the tool body 98.

The control section 99 controls operation of the entire electric power tool (including a usage state of the power supply 100), and includes, for example, a CPU. The power supply 100 includes one or more secondary batteries (not illustrated). The control section 99 allows the power supply 100 to supply power to the drill section 101 as necessary according to an operation of an operation switch (not illustrated), thereby bringing the drill section 101 into operation.

### EXAMPLES

Examples of the embodiment of the application will be described in detail below.

### Experimental Example 1-1 to 1-20

The cylindrical type lithium-ion secondary batteries illustrated in FIGS. 1 and 2 were fabricated by the following steps.

The cathode 21 was formed by following steps. First, lithium carbonate (Li₂CO₃) and cobalt carbonate (CoCO₃) were mixed at a mole ratio of Li₂CO₃:CoCO₃=0.5:1 to form a mixture, and then the mixture was fired in air at 900° C. for 5 hours to obtain lithium cobalt complex oxide (LiCoO₂). Next, 94 parts by mass of the cathode active material (lithium cobalt complex oxide: LiCoO₂), 3 parts by mass of the cathode binder (polyvinylidene fluoride: PVDF), and 3 parts by mass of the cathode conductor (graphite) were mixed to form a cathode mixture. Next, the cathode mixture was dispersed in the organic solvent (N-methyl-2-pyrrolidone: NMP) to form paste-form cathode mixture slurry. Then, the cathode mixture slurry was uniformly applied to both surfaces of the strip-like cathode current collector 21A (aluminum foil with a thickness of 10 μm) by a coating unit, and the cathode mixture slurry was dried to form the cathode active material layer 21B. Finally, the cathode active material layer 21B was compression molded by a roller press (thickness=80 μm, volume density=3.7 g/cm³).

The anode 22 was formed by the following steps. First, 90 parts by mass of the anode active material (artificial graphite) and 10 parts by mass of the anode binder (PVDF) were mixed to form an anode mixture. Next, the anode mixture was dispersed in the organic solvent (NMP) to form paste-form anode mixture slurry. Then, the anode mixture slurry was uniformly applied to both surfaces of the strip-like anode current collector 22A (electrolytic copper foil with a thickness of 10 μm) by a coating unit, and the anode mixture slurry was dried to form the anode active material layer 22B. Finally, the anode active material layer 22B was compression molded by a roller press (thickness=50 μm, volume density=1.6 g/cm³).

To prepare the electrolytic solution, the electrolyte salt (LiPF₆) was dissolved in the solvent (ethylene carbonate (EC) and dimethyl carbonate (DMC)), and then, as illustrated in Table 1, the unsaturated cyclic ester carbonate was added to the solvent, as necessary. In this case, the composition of the solvent was EC:DMC=50:50 in weight ratio, and the content of the electrolyte salt was 1 mol/kg relative to the solvent.

The secondary battery was assembled by the following steps. First, the cathode lead 25 made of aluminum was welded to the cathode current collector 21A, and the anode lead 26 made of nickel was welded to the anode current collector 22A. Next, the cathode 21 and the anode 22 were laminated with the separator 23 (a microporous polypropylene film with a thickness of 25 μm) in between, and were spirally wound to form a spirally wound body, and then an outermost portion of the spirally wound body was fixed by an adhesive tape to form the spirally wound electrode body 20. Next, the center pin 24 was inserted into the center of the spirally wound electrode body 20. Then, the spirally wound electrode body 20 sandwiched between the pair of insulating plates 12 and 13 was contained in the battery can 11 made of nickel-plated iron. In this case, an end of the cathode lead 25 and an end of the anode lead 26 were welded to the safety valve mechanism 15 and the battery can 11, respectively. Next, the electrolytic solution was injected into the battery can 11 by a decompression method to impregnate the separator 23 with the electrolytic solution. Finally, the battery cover 14, the safety valve mechanism 15, and the PTC device 16 were caulked in an open end of the battery can 11 by the gasket 17. Thus, each of the cylindrical type secondary batteries was completed. When each of the secondary batteries was formed, the thickness of the cathode active material layer 21B was adjusted to prevent deposition of lithium metal on the anode 22 in a fully-charged state.

When battery characteristics (continuous charge characteristics) of the secondary batteries were determined, results illustrated in Table 1 were obtained.

To determine the continuous charge characteristics, one cycle of charge and discharge was performed on each of the secondary batteries in a room temperature environment (at 23° C.) to stabilize its battery state. Next, one more cycle of charge and discharge was performed on each of the secondary batteries in the same environment to determine its discharge capacity. Next, each of the secondary batteries was charged at a constant current (a current=0.5 C) in a high-temperature environment (at 60° C.) until reaching a fully-charged state, and then was charged at a constant voltage continuously (100 hours). Then, each of the secondary batteries was discharged to determine its discharge capacity. The charge voltage (the upper limit) under the fully-charged state was as illustrated in Table 1. A continuous charge retention ratio (%)=(discharge capacity before continuous charge/discharge capacity after continuous charge)ₓ₁₀₀ was determined from these results by calculation. As conditions of charge other than the above-described conditions during continuous charge, each of the secondary batteries was charged at a current of 1 C until the voltage reached an upper-limit voltage of 4.2 V, and then each of the secondary batteries was further charged at a constant voltage until total charge time from the start of charge at the constant voltage reached 3 hours. As the conditions of discharge, each of the secondary batteries was discharged at a current of 1 C until the voltage reached a cutoff voltage of 3 V. It is to be noted that “0.5 C” and “1 C” represent a current value at which the capacity (theoretical capacity) of a battery is fully discharged for 2 hours and 1 hour, respectively. It is to be noted that, to determine the continuous charge characteristics, in addition to the above-described continuous charge retention ratio, a leakage current (mA) during continuous charge was determined.

TABLE 1
Cathode active material: LiCoO₂, Thickness and volume density of cathode active
material layer = 80 μm and 3.7 g/cm³, respectively
Anode active material: artificial graphite, Thickness and volume density of anode
active material layer = 50 μm and 1.6 g/cm³, respectively

| | | Electrolytic Solution | | | | Continuous | |
|---|---|---|---|---|---|---|---|
| | | | | Unsaturated Cyclic | | Charge | |
| | Charge | | | Ester Carbonate | | Retention | Leakage |
| Experimental | Voltage | Electrolyte | | | Content | Ratio | Current |
| Example | (V) | Salt | Solvent | Kind | (wt %) | (%) | (mA) |
| 1-1 | 4.3 | LiPF6 | EC + DMC | Expression | 0.01 | 80 | 1.4 |
| 1-2 | | | | (1-1) | 0.1 | 81 | 1.2 |
| 1-3 | | | | | 0.5 | 82 | 1 |
| 1-4 | | | | | 1 | 85 | 0.9 |
| 1-5 | | | | | 2 | 85 | 0.8 |
| 1-6 | | | | | 5 | 84 | 0.8 |
| 1-7 | | | | | 10 | 83 | 0.8 |
| 1-8 | 4.3 | LiPF₆ | EC + DMC | Expression | 2 | 82 | 1 |
| | | | | (1-4) | | | |
| 1-9 | | | | Expression | 2 | 83 | 1 |
| | | | | (1-16) | | | |
| 1-10 | | | | Expression | 2 | 82 | 1 |
| | | | | (1-18) | | | |
| 1-11 | | | | Expression | 2 | 84 | 1 |
| | | | | (1-32) | | | |
| 1-12 | 4.35 | LiPF₆ | EC + DMC | Expression | 2 | 80 | 1.2 |
| 1-13 | 4.4 | | | (1-1) | | 73 | 2 |
| 1-14 | 4.5 | | | | | 66 | 5.5 |
| 1-15 | 4.25 | LiPF₆ | EC + DMC | — | — | 85 | 0.8 |
| 1-16 | | | | Expression | 2 | 85 | 0.8 |
| | | | | (1-1) | | | |
| 1-17 | 4.3 | | | — | — | 78 | 1.5 |
| 1-18 | 4.35 | | | | | 70 | 4.2 |
| 1-19 | 4.4 | | | | | 62 | 10.2 |
| 1-20 | 4.5 | | | | | 52 | 15.3 |

When the carbon material (artificial graphite) was used as the anode active material, the battery characteristics exhibited a specific tendency according to a relationship between a charge voltage value and the presence or absence of the unsaturated cyclic ester carbonate in the electrolytic solution.

More specifically, in the case where the charge voltage was smaller than 4.3 V, even if the unsaturated cyclic ester carbonate was included in the electrolytic solution, the continuous charge retention ratio and the leakage current were not varied. This result indicates that when the charge voltage is low, decomposition reaction of the electrolytic solution caused by the charge voltage hardly proceeds; therefore, the unsaturated cyclic ester carbonate does not substantially fulfill a function of suppressing decomposition of the electrolytic solution.

On the other hand, in the case where the charge voltage was 4.3 V or over, when the unsaturated cyclic ester carbonate was included in the electrolytic solution, the continuous charge retention ratio was increased, and the leakage current was decreased. This result indicates that when the charge voltage is high, decomposition reaction of the electrolytic solution caused by the charge voltage easily proceeds; therefore, the unsaturated cyclic ester carbonate efficiently fulfills the function of suppressing decomposition of the electrolytic solution.

In particular, in the case where the charge voltage was 4.3 V or over and the electrolytic solution included the unsaturated cyclic ester carbonate, when the content of the unsaturated cyclic ester carbonate was within a range of 0.01 wt % to 10 wt % both inclusive, a high continuous charge retention ratio was obtained, and the leakage current was maintained low. In this case, when the content was within a range of 1 wt % to 10 wt % both inclusive, the continuous charge retention ratio was further increased, and the leakage current was further decreased.

### Experimental Example 2-1 to 2-12

Secondary batteries were fabricated by steps similar to those in Experimental Example 1-5, except that the composition of the solvent was changed as illustrated in Table 2, and various characteristics of the secondary batteries were determined.

The following solvents were used herein. Another unsaturated cyclic ester carbonate was vinylene carbonate (VC). The halogenated ester carbonate was 4-fluoro-1,3-dioxolane-2-one (FEC), trans-4,5-difluoro-1,3-dioxolane-2-one (t-DFEC), cis-4,5-difluoro-1,3-dioxolane-2-one (c-DFEC), or bis(fluoromethyl) carbonate (DFDMC). The sultone was propene sultone (PRS). The acid anhydride was succinic anhydride (SCAH) or sulfopropionic anhydride (PSAH).

The content of VC in the solvent was 2 wt %, the contents of FEC, t-DFEC, c-DFEC, and DFDMC in the solvent were 5 wt %, and the contents of PRS, SCAH, and PSAH were 1 wt %.

TABLE 2
Cathode active material: LiCoO₂, Thickness and volume density of cathode active
material layer = 80 μm and 3.7 g/cm³, respectively
Anode active material: artificial graphite, Thickness and volume density of anode
active material layer = 50 μm and 1.6 g/cm³, respectively

| | | Electrolytic Solution | | | | | Continuous | |
|---|---|---|---|---|---|---|---|---|
| | | | | | Unsaturated Cyclic | | Charge | |
| | Charge | | | | Ester Carbonate | | Retention | Leakage |
| Experimental | Voltage | Electrolyte | | | | Content | Ratio | Current |
| Example | (V) | Salt | Solvent | | Kind | (wt %) | (%) | (mA) |
| 2-1 | 4.3 | LiPF₆ | EC + | VC | Expression | 2 | 88 | 0.8 |
| 2-2 | | | DMC | FEC | (1-1) | | 87 | 0.8 |
| 2-3 | | | | t-DFEC | | | 87 | 0.8 |
| 2-4 | | | | c-DFEC | | | 87 | 0.8 |
| 2-5 | | | | DFDMC | | | 87 | 0.8 |
| 2-6 | | | | PRS | | | 90 | 0.7 |
| 2-7 | | | | SCAH | | | 90 | 0.8 |
| 2-8 | | | | PSAH | | | 95 | 0.6 |
| 2-9 | 4.3 | LiPF₆ | EC + | VC | — | — | 80 | 1.2 |
| 2-10 | | | DMC | FEC | | | 79 | 1.3 |
| 2-11 | | | | t-DFEC | | | 78 | 1.3 |
| 2-12 | | | | DFDMC | | | 78 | 1.3 |

Even though the composition of the solvent was changed, a high continuous charge retention ratio was obtained, and the leakage current was maintained low. In particular, when the electrolytic solution included another unsaturated cyclic ester carbonate, the halogenated ester carbonate, the sultone, or the acid anhydride, the continuous charge retention ratio was further increased, and the leakage current was further decreased depending on the composition of the solvent.

### Experimental Example 3-1 to 3-3

Secondary batteries were fabricated by steps similar to those in Experimental Example 1-5, except that the composition of the electrolyte salt was changed as illustrated in Table 3, and various characteristics of the secondary batteries were determined.

The electrolyte salt used herein was lithium tetrafluoroborate (LiBF₄), lithium bis[oxalato-O,O′]borate (LiBOB) represented by the expression (8-6), or lithium bis(trifluoromethane-sulfonyl)imide (LiN(CF₃SO₂)₂: LiTFSI). The content of LiPF₆ was 0.9 mol/kg relative to the solvent, and the content of LiBF₄ or the like was 0.1 mol/kg relative to the solvent.

TABLE 3
Cathode active material: LiCoO₂, Thickness and volume density of cathode active
material layer = 80 μm and 3.7 g/cm³, respectively
Anode active material: artificial graphite, Thickness and volume density of anode
active material layer = 50 μm and 1.6 g/cm³, respectively

| | | Electrolytic Solution | | | | | Continuous | |
|---|---|---|---|---|---|---|---|---|
| | | | | | Unsaturated Cyclic | | Charge | |
| | Charge | | | | Ester Carbonate | | Retention | Leakage |
| Experimental | Voltage | Electrolyte | | | | Content | Ratio | Current |
| Example | (V) | Salt | | Solvent | Kind | (wt %) | (%) | (mA) |
| 3-1 | 4.3 | LiPF₆ | LiBF₄ | EC + | Expression | 2 | 88 | 0.8 |
| 3-2 | | | LiBOB | DMC | (1-1) | | 88 | 0.7 |
| 3-3 | | | LiTFSI | | | | 90 | 0.6 |

Even though the composition of the electrolyte salt was changed, a high continuous charge retention ratio was obtained, and the leakage current was maintained low. In particular, when the electrolytic solution included another electrolyte salt such as LiBF₄, the continuous charge retention ratio was further increased, and the leakage current was further decreased depending on the composition of the solvent.

### Experimental Examples 4-1 to 4-22

Secondary batteries were fabricated by steps similar to those in Experimental Examples 1-1 to 1-20, except that the kind of the cathode active material was changed as illustrated in Table 4, and various characteristics of the secondary batteries were determined.

The cathode 21 was formed by the following steps. First, lithium hydroxide (LiOH) and Mn_{0.67}Co_{0.17}Ni_{0.17}(OH)₂ formed by a coprecipitation method were mixed at a desired stoichiometric ratio to form a mixture. Next, the mixture was molded into a pellet form, and then the mixture was fired in air at 900° C. for 24 hours to obtain lithium-rich lithium transition metal complex oxide (Li_{1.2}Mn_{0.54}Co_{0.13}Ni_{0.13}O₂). When Li_{1.2}Mn_{0.54}Co_{0.13}Ni_{0.13}O₂ was analyzed by a powder X-ray diffraction method, a mixture phase of a structure belonging to a space group R3-m and a structure belonging to a space group C2/m was observed. Next, 90 parts by mass of the cathode active material (Li_{1.2}Mn_{0.54}Co_{0.13}Ni_{0.13}O₂), 5 parts by mass of the cathode binder (PVDF), and 5 parts by mass of the cathode conductor (acetylene black) were mixed to form a cathode mixture. Next, the cathode mixture was dispersed in the organic solvent (NMP) to form paste-form cathode mixture slurry. Then, the cathode mixture slurry was uniformly applied to both surfaces of the strip-like cathode current collector 21A (aluminum foil with a thickness of 10 μm) by a coating unit, and the cathode mixture slurry was dried to form the cathode active material layer 21B. Finally, the cathode active material layer 21B was compression molded by a roller press.

TABLE 4
Cathode active material: Li_{1.2}Mn_{0.54}Co_{0.13}Ni_{0.13}O₂, Thickness and volume density of
cathode active material layer = 80 μm and 3.7 g/cm³, respectively
Anode active material: artificial graphite, Thickness and volume density of anode
active material layer = 50 μm and 1.6 g/cm³, respectively

| | | Electrolytic Solution | | | | Continuous | |
|---|---|---|---|---|---|---|---|
| | | | | Unsaturated Cyclic | | Charge | |
| | Charge | | | Ester Carbonate | | Retention | Leakage |
| Experimental | Voltage | Electrolyte | | | Content | Ratio | Current |
| Example | (V) | Salt | Solvent | Kind | (wt %) | (%) | (mA) |
| 4-1 | 4.6 | LiPF₆ | EC + DMC | Expression | 0.01 | 80 | 18 |
| 4-2 | | | | (1-1) | 0.1 | 81 | 13 |
| 4-3 | | | | | 0.5 | 82 | 10 |
| 4-4 | | | | | 1 | 87 | 8 |
| 4-5 | | | | | 2 | 88 | 4 |
| 4-6 | | | | | 5 | 88 | 4 |
| 4-7 | | | | | 10 | 86 | 4 |
| 4-8 | 4.6 | LiPF₆ | EC + DMC | Expression | 2 | 84 | 4.6 |
| | | | | (1-4) | | | |
| 4-9 | | | | Expression | 2 | 85 | 4.8 |
| | | | | (1-16) | | | |
| 4-10 | | | | Expression | 2 | 84 | 4.8 |
| | | | | (1-18) | | | |
| 4-11 | | | | Expression | 2 | 86 | 4.2 |
| | | | | (1-32) | | | |
| 4-12 | 4.3 | LiPF₆ | EC + DMC | Expression | 2 | 92 | 1.5 |
| 4-13 | 4.4 | | | (1-1) | | 90 | 2.5 |
| 4-14 | 4.5 | | | | | 90 | 3.6 |
| 4-15 | 4.8 | | | | | 80 | 7.5 |
| 4-16 | 4.25 | LiPF₆ | EC + DMC | — | — | 93 | 1.2 |
| 4-17 | | | | Expression | 2 | 92 | 1.2 |
| | | | | (1-1) | | | |
| 4-18 | 4.3 | | | — | — | 85 | 5.5 |
| 4-19 | 4.4 | | | | | 80 | 12 |
| 4-20 | 4.5 | | | | | 78 | 15 |
| 4-21 | 4.6 | | | | | 75 | 20 |
| 4-22 | 4.8 | | | | | 60 | 100 |

Even though the kind of the cathode active material was changed, results similar to those in Table 1 were obtained. In other words, in the case where the charge voltage was 4.3 V or over, when the electrolytic solution included the unsaturated cyclic ester carbonate, a high continuous charge retention ratio was obtained, and the leakage current was maintained low. A tendency other than this in Table 4 is similar to that in Table 1.

### Experimental Examples 5-1 to 5-20, 6-1 to 6-12, and 7-1 to 7-3

Secondary batteries were fabricated by steps similar to those in Experimental Examples 1-1 to 1-20, 2-1 to 2-12, and 3-1 to 3-3, except that a metal-based material (silicon) was used as the anode active material, and various characteristics of the secondary batteries were determined.

When the anode 22 was formed, silicon was deposited on both surfaces of the anode current collector 22A by an electron beam evaporation method to form the anode active material layer 22B. In this case, a deposition step was repeated 10 times to allow the anode active material layer 22B on one surface of the anode current collector 22A to have a total thickness of 6 μm.

TABLE 5
Cathode active material: LiCoO₂, Anode active material: silicon

| | | Electrolytic Solution | | | | Continuous | |
|---|---|---|---|---|---|---|---|
| | | | | Unsaturated Cyclic | | Charge | |
| | Charge | | | Ester Carbonate | | Retention | Leakage |
| Experimental | Voltage | Electrolyte | | | Content | Ratio | Current |
| Example | (V) | Salt | Solvent | Kind | (wt %) | (%) | (mA) |
| 5-1 | 4.3 | LiPF₆ | EC + DMC | Expression | 0.01 | 75 | 1.5 |
| 5-2 | | | | (1-1) | 0.1 | 78 | 1.3 |
| 5-3 | | | | | 0.5 | 80 | 1.1 |
| 5-4 | | | | | 1 | 82 | 1 |
| 5-5 | | | | | 2 | 85 | 0.8 |
| 5-6 | | | | | 5 | 85 | 0.8 |
| 5-7 | | | | | 10 | 82 | 0.8 |
| 5-8 | 4.3 | LiPF₆ | EC + DMC | Expression | 2 | 82 | 0.8 |
| | | | | (1-4) | | | |
| 5-9 | | | | Expression | 2 | 82 | 0.8 |
| | | | | (1-16) | | | |
| 5-10 | | | | Expression | 2 | 83 | 0.8 |
| | | | | (1-18) | | | |
| 5-11 | | | | Expression | 2 | 84 | 0.8 |
| | | | | (1-32) | | | |
| 5-12 | 4.35 | LiPF₆ | EC + DMC | Expression | 2 | 80 | 1.3 |
| 5-13 | 4.4 | | | (1-1) | 2 | 75 | 2.2 |
| 5-14 | 4.5 | | | | | 70 | 5.8 |
| 5-15 | 4.25 | LiPF₆ | EC + DMC | — | — | 80 | 1 |
| 5-16 | | | | Expression | 2 | 80 | 1.1 |
| | | | | (1-1) | | | |
| 5-17 | 4.3 | | | — | — | 73 | 2 |
| 5-18 | 4.35 | | | | | 60 | 6.2 |
| 5-19 | 4.4 | | | | | 55 | 14.2 |
| 5-20 | 4.5 | | | | | 40 | 20.3 |

TABLE 6
Cathode active material: LiCoO₂, Anode active material: silicon

| | | Electrolytic Solution | | | | | Continuous | |
|---|---|---|---|---|---|---|---|---|
| | | | | | Unsaturated Cyclic | | Charge | |
| | Charge | | | | Ester Carbonate | | Retention | Leakage |
| Experimental | Voltage | Electrolyte | | | | Content | Ratio | Current |
| Example | (V) | Salt | Solvent | | Kind | (wt %) | (%) | (mA) |
| 6-1 | 4.6 | LiPF₆ | EC + | VC | Expression | 2 | 87 | 0.8 |
| 6-2 | | | DMC | FEC | (1-1) | | 87 | 0.8 |
| 6-3 | | | | t-DFEC | | | 88 | 0.8 |
| 6-4 | | | | c-DFEC | | | 88 | 0.8 |
| 6-5 | | | | DFDMC | | | 88 | 0.8 |
| 6-6 | | | | PRS | | | 92 | 0.7 |
| 6-7 | | | | SCAH | | | 90 | 0.8 |
| 6-8 | | | | PSAH | | | 95 | 0.6 |
| 6-9 | 4.6 | LiPF₆ | EC + | VC | — | — | 76 | 1.2 |
| 6-10 | | | DMC | FEC | | | 74 | 1.3 |
| 6-11 | | | | t-DFEC | | | 75 | 1.3 |
| 6-12 | | | | DFDMC | | | 75 | 1.3 |

TABLE 7
Cathode active material: LiCoO₂, Anode active material: silicon

| | | Electrolytic Solution | | | | | Continuous | |
|---|---|---|---|---|---|---|---|---|
| | | | | | Unsaturated Cyclic | | Charge | |
| | Charge | | | | Ester Carbonate | | Retention | Leakage |
| Experimental | Voltage | Electrolyte | | | | Content | Ratio | Current |
| Example | (V) | Salt | | Solvent | Kind | (wt %) | (%) | (mA) |
| 7-1 | 4.6 | LiPF₆ | LiBF₄ | EC + DMC | Expression | 2 | 88 | 0.8 |
| 7-2 | | | LiBOB | | (1-1) | | 88 | 0.7 |
| 7-3 | | | LiTFSI | | | | 90 | 0.6 |

Even though the metal-based material (silicon) was used as the anode active material, results similar to those in the case where the carbon material was used (Tables 1 to 3) were obtained. In other words, in the case where the charge voltage was 4.3 V or over, when the electrolytic solution included the unsaturated cyclic ester carbonate, a high continuous charge retention ratio was obtained, and the leakage current was maintained low. A tendency other than this is similar to that in the case where the carbon material was used.

### Experimental Examples 8-1 to 8-18 and 9-1 to 9-10

As illustrated in Tables 8 and 9, secondary batteries were fabricated by steps similar to those in Experimental Examples 1-5 and 1-17, except that the thickness (μm) and volume density (g/cm³) of the cathode active material layer 21B was changed, and characteristics (cycle characteristics) of the secondary batteries were determined. As used in the tables, the term “increase amount” refers to a difference (a change amount) in a cycle retention ratio between the presence and the absence of the unsaturated cyclic ester carbonate. It is to be noted that rating capacity (mAh) of the secondary battery including the cathode active material layer 21B with a thickness of 80 μm was 2400 mAh (volume density=3.5 g/cm³), 2500 mAh (volume density=3.6 g/cm³), 2650 mAh (volume density=3.7 g/cm³), 2700 mAh (volume density=3.8 g/cm³), and 2750 mAh (volume density=3.9 g/cm³).

To determine the cycle characteristics, one cycle of charge and discharge was performed on each of the secondary batteries in a stabilized battery state in a room temperature environment (at 23° C.) by steps similar to the case where the continuous charge characteristics were determined to determine its discharge capacity. Next, charge and discharge were repeatedly performed on each of the secondary batteries in the same environment until the total cycle number reached 100 cycles to determine its discharge capacity. A cycle retention ratio (%)=(discharge capacity in 100th cycle/discharge capacity in second cycle)×100 was determined from these results by calculation. When charge was performed, each of the secondary batteries was charged at a current of 0.2 C until the voltage reached an upper-limit voltage of 4.2 V, and then each of the secondary batteries was further charged at a voltage of 4.2 V until the current reached 0.05 C. When discharge was performed, each of the secondary batteries was discharged at a current of 0.2 C until the voltage reached a cutoff voltage of 2.5 V. It is to be noted that “0.2 C” and “0.05 C” represent a current value at which the capacity (theoretical capacity) of a battery is fully discharged for 5 hours and 20 hours, respectively.

TABLE 8
Cathode active material: LiCoO₂, Volume density of cathode active material layer = 3.7 g/cm³
Anode active material: artificial graphite, Thickness and volume density of anode
active material layer = 50 μm and 1.6 g/cm³, respectively

| | | | Electrolytic Solution | | | | | |
|---|---|---|---|---|---|---|---|---|
| | | | | | Unsaturated Cyclic | | Cycle | |
| | Charge | Cathode | | | Ester Carbonate | | Retention | |
| Experimental | Voltage | Thickness | Electrolyte | | | Content | Ratio | Increase |
| Example | (V) | (μm) | Salt | Solvent | Kind | (wt %) | (%) | Amount |
| 8-1 | 4.3 | 10 | LiPF₆ | EC + DMC | Expression | 2 | 95 | +3 |
| 8-2 | | 30 | | | (1-1) | | 93 | +7 |
| 8-3 | | 40 | | | | | 92 | +12 |
| 8-4 | | 50 | | | | | 90 | +15 |
| 8-5 | | 60 | | | | | 88 | +20 |
| 8-6 | | 70 | | | | | 86 | +23 |
| 8-7 | | 80 | | | | | 88 | +32 |
| 8-8 | | 90 | | | | | 76 | +24 |
| 8-9 | | 100 | | | | | 62 | +22 |
| 8-10 | 4.3 | 10 | LiPF₆ | EC + DMC | — | — | 92 | — |
| 8-11 | | 30 | | | | | 86 | — |
| 8-12 | | 40 | | | | | 80 | — |
| 8-13 | | 50 | | | | | 75 | — |
| 8-14 | | 60 | | | | | 68 | — |
| 8-15 | | 70 | | | | | 63 | — |
| 8-16 | | 80 | | | | | 56 | — |
| 8-17 | | 90 | | | | | 52 | — |
| 8-18 | | 100 | | | | | 40 | — |

TABLE 9
Cathode active material: LiCoO₂, Thickness of cathode active material layer = 80 μm
Anode active material: artificial graphite, Thickness and volume density of anode
active material layer = 50 μm and 1.6 g/cm³, respectively

| | | | Electrolytic Solution | | | | | |
|---|---|---|---|---|---|---|---|---|
| | | Cathode | | | Unsaturated Cyclic | | Cycle | |
| | Charge | Volume | | | Ester Carbonate | | Retention | |
| Experimental | Voltage | Density | Electrolyte | | | Content | Ratio | Increase |
| Example | (V) | (g/cm³) | Salt | Solvent | Kind | (wt %) | (%) | Amount |
| 9-1 | 4.3 | 3.5 | LiPF₆ | EC + DMC | Expression | 2 | 89 | +28 |
| 9-2 | | 3.6 | | | (1-1) | | 88 | +30 |
| 9-3 | | 3.7 | | | | | 88 | +32 |
| 9-4 | | 3.8 | | | | | 87 | +30 |
| 9-5 | | 3.9 | | | | | 86 | +30 |
| 9-6 | 4.3 | 3.5 | LiPF₆ | EC + DMC | — | — | 61 | — |
| 9-7 | | 3.6 | | | | | 58 | — |
| 9-8 | | 3.7 | | | | | 56 | — |
| 9-9 | | 3.8 | | | | | 57 | — |
| 9-10 | | 3.9 | | | | | 56 | — |

Even though the thickness of the cathode active material layer 21B was changed, a high cycle retention ratio was obtained with use of the unsaturated cyclic ester carbonate. In particular, when the thickness of the cathode active material layer 21B was 40 μm or over, the increase amount of the cycle retention ratio was in double digits. This result indicates that when the thickness of the cathode active material layer 21B is 40 μm or over, chemical stability of the electrolytic solution is effectively maintained by the unsaturated cyclic ester carbonate; therefore, decomposition reaction of the electrolytic solution is minimized. In this case, when the thickness of the cathode active material layer 21B was 100 μm or less, and the volume density of the cathode active material layer 21B was within a range of 3.5 g/cm³ to 3.9 g/cm³ both inclusive, a high cycle retention ratio was obtained.

### Experimental Examples 10-1 to 10-10

As illustrated in Table 10, secondary batteries were fabricated by steps similar to those in Experimental Examples 1-5, 1-17 and the like, except that the charge voltage (an upper limit value) was changed, and characteristics (cycle characteristics) of the secondary batteries were determined.

TABLE 10
Cathode active material: LiCoO₂, Thickness and volume density of cathode active
material layer = 80 μm and 3.7 g/cm³, respectively
Anode active material: artificial graphite, Thickness and volume density of anode
active material layer = 50 μm and 1.6 g/cm³, respectively

| | | Electrolytic Solution | | | | | |
|---|---|---|---|---|---|---|---|
| | | | | Unsaturated Cyclic | | Cycle | |
| | Charge | | | Ester Carbonate | | Retention | |
| Experimental | Voltage | Electrolyte | | | Content | Ratio | Increase |
| Example | (V) | Salt | Solvent | Kind | (wt %) | (%) | Amount |
| 10-1 | 4.3 | LiPF₆ | EC + DMC | Expression | 2 | 88 | +32 |
| 10-2 | 4.35 | | | (1-1) | | 85 | +37 |
| 10-3 | 4.4 | | | | | 77 | +35 |
| 10-4 | 4.45 | | | | | 68 | +33 |
| 10-5 | 4.5 | | | | | 58 | +30 |
| 10-6 | 4.3 | LiPF₆ | EC + DMC | — | — | 56 | — |
| 10-7 | 4.35 | | | | | 48 | — |
| 10-8 | 4.4 | | | | | 42 | — |
| 10-9 | 4.45 | | | | | 35 | — |
| 10-10 | 4.5 | | | | | 28 | — |

Even though the charge voltage was changed, a high cycle retention ratio was obtained with use of the unsaturated cyclic ester carbonate. The increase amounts in all of the secondary batteries in this case were in double digits.

### Experimental Examples 11-1 to 11-16 and 12-1 to 12-10

As illustrated in Tables 11 and 12, secondary batteries were fabricated by steps similar to those in Experimental Examples 1-5 and 1-17, except that the thickness (μm) and the volume density (g/cm³) of the anode active material layer 22B were changed, and characteristics (cycle characteristics) of the secondary batteries were determined. It is to be noted that rating capacity (mAh) of the secondary battery including the anode active material layer 22B with a thickness of 50 μm was 2050 mAh (volume density=1.4 g/cm³), 2100 mAh (volume density=1.5 g/cm³), 2200 mAh (volume density=1.6 g/cm³), 2350 mAh (volume density=1.7 g/cm³), and 2500 mAh (volume density=1.8 g/cm³). Steps of determining the cycle characteristics are similar to those in Experimental Examples 8-1 to 8-18, and 9-1 to 9-10, except that second to 100th cycles of charge and discharge were performed in a high-temperature environment (45° C.).

TABLE 11
Cathode active material: LiCoO₂, Thickness and volume density of cathode active
material layer = 80 μm and 3.7 g/cm³, respectively
Anode active material: artificial graphite, Volume density of anode active material
layer = 1.6 g/cm³

| | | | Electrolytic Solution | | | | | |
|---|---|---|---|---|---|---|---|---|
| | | | | | Unsaturated Cyclic | | Cycle | |
| | Charge | Cathode | | | Ester Carbonate | | Retention | |
| Experimental | Voltage | Thickness | Electrolyte | | | Content | Ratio | Increase |
| Example | (V) | (μm) | Salt | Solvent | Kind | (wt %) | (%) | Amount |
| 11-1 | 4.3 | 10 | LiPF₆ | EC + DMC | Expression | 2 | 93 | +8 |
| 11-2 | | 20 | | | (1-1) | | 93 | +15 |
| 11-3 | | 30 | | | | | 90 | +18 |
| 11-4 | | 40 | | | | | 87 | +33 |
| 11-5 | | 50 | | | | | 80 | +32 |
| 11-6 | | 60 | | | | | 82 | +40 |
| 11-7 | | 70 | | | | | 72 | +36 |
| 11-8 | | 100 | | | | | 56 | +23 |
| 11-9 | 4.3 | 10 | LiPF₆ | EC + DMC | — | — | 85 | — |
| 11-10 | | 20 | | | | | 78 | — |
| 11-11 | | 30 | | | | | 72 | — |
| 11-12 | | 40 | | | | | 54 | — |
| 11-13 | | 50 | | | | | 48 | — |
| 11-14 | | 60 | | | | | 42 | — |
| 11-15 | | 70 | | | | | 36 | — |
| 11-16 | | 100 | | | | | 33 | — |

TABLE 12
Cathode active material: LiCoO₂, Thickness and volume density of cathode active
material layer = 80 μm and 3.7 g/cm³, respectively
Anode active material: artificial graphite, Thickness of anode active material layer = 50 μm

| | | | Electrolytic Solution | | | | | |
|---|---|---|---|---|---|---|---|---|
| | | Anode | | | Unsaturated Cyclic | | Cycle | |
| | Charge | Volume | | | Ester Carbonate | | Retention | |
| Experimental | Voltage | Density | Electrolyte | | | Content | Ratio | Increase |
| Example | (V) | (g/cm³) | Salt | Solvent | Kind | (wt %) | (%) | Amount |
| 12-1 | 4.3 | 1.4 | LiPF₆ | EC + DMC | Expression | 2 | 84 | +29 |
| 12-2 | | 1.5 | | | (1-1) | | 82 | +30 |
| 12-3 | | 1.6 | | | | | 80 | +32 |
| 12-4 | | 1.7 | | | | | 80 | +36 |
| 12-5 | | 1.8 | | | | | 78 | +38 |
| 12-6 | 4.3 | 1.4 | LiPF₆ | EC + DMC | — | — | 55 | — |
| 12-7 | | 1.5 | | | | | 52 | — |
| 12-8 | | 1.6 | | | | | 48 | — |
| 12-9 | | 1.7 | | | | | 44 | — |
| 12-10 | | 1.8 | | | | | 42 | — |

Even though the thickness of the anode active material layer 22B was changed, a high cycle retention ratio was obtained with use of the unsaturated cyclic ester carbonate. In particular, when the thickness of the anode active material layer 22B was 20 μm or over, the increase amount of the cycle retention ratio was in double digits. This result indicates that, as with the thickness of the cathode active material layer 21B, when the thickness of the anode active material layer 22B was 20 μm or over, decomposition reaction of the electrolytic solution is minimized. In this case, when the thickness of the anode active material layer 22B was 100 μm or less, and the volume density of the anode active material layer 22B was within a range of 1.4 g/cm³ to 1.8 g/cm³ both inclusive, a high cycle retention ratio was obtained.

The results in Tables 1 to 12 showed that, when the open-circuit voltage under the fully-charged state per pair of the cathode and the anode was 4.3 V or over and the electrolytic solution included the unsaturated cyclic ester carbonate, superior battery characteristics were obtained.

Although the present application is described referring to the embodiment and the examples, the application is not limited thereto, and may be variously modified. For example, as the kind of secondary battery, the lithium-ion secondary battery is described; however, the application is not limited thereto. The application is also applicable, in a similar manner, to a secondary battery in which the capacity of an anode includes a capacity by insertion and extraction of lithium ions and a capacity associated with deposition and dissolution of lithium metal and its battery capacity is represented by the sum of them. In this case, an anode material capable of inserting and extracting lithium ions is used as the anode active material, and a chargeable capacity of the anode material is set to be smaller than the discharge capacity of a cathode.

Moreover, the case where the battery configuration is the cylindrical type or the laminate film type and the battery device has a spirally wound configuration is described as an example; however, the application is not limited thereto. The application is also applicable, in a similar manner, to the case where the secondary battery has any other battery configuration such as a prismatic type, a coin type, or a button type, and the case where the battery device has any other configuration such as a laminate configuration.

Further, the case where Li is used as the electrode reactant is described; however, the application is not limited thereto. For example, the electrode reactant may be any other Group 1 element such as Na or K, a Group 2 element such as Mg or Ca, or any other light metal such as Al. Since the effects of the application are supposed to be obtained without relying on the kind of the electrode reactant, even if the kind of the electrode reactant is changed, similar effects are obtainable.

Moreover, an appropriate range, which is derived from the results of the examples, of the content of the unsaturated cyclic ester carbonate is described; however, the description does not exclude the possibility that the content is out of the above-described range. More specifically, the above-described appropriate range is a specifically preferable range to obtain the effects of the application, and as long as the effects of the application are obtained, the content may be deviated from the above-described range to some extent. The same applies to the thickness of the cathode active material layer and the thickness of the anode active material layer.

It is to be noted that the application may have the following configurations.

(1) A secondary battery including:

a cathode;

an anode; and

an electrolytic solution,

in which an open-circuit voltage under a fully-charged state per pair of the cathode and the anode is about 4.3 V or over, and

the electrolytic solution includes an unsaturated cyclic ester carbonate represented by an expression (1):

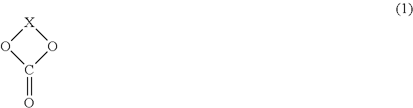

where X is a divalent group in which m-number of >C═CR1R2 and n-number of >CR3R4 are bonded in any order, R1 to R4 each are a hydrogen group, a halogen group, a monovalent hydrocarbon group, a monovalent halogenated hydrocarbon group, a monovalent oxygen-containing hydrocarbon group, or a monovalent halogenated oxygen-containing hydrocarbon group, any two or more of R1 to R4 may be bonded to one another, and m and n satisfy m≧1 and n≧0, respectively.

(2) The secondary battery according to (1), in which

the halogen group is a fluorine group, a chlorine group, a bromine group, or a an iodine group, and

the monovalent hydrocarbon group, the monovalent halogenated hydrocarbon group, a monovalent oxygen-containing hydrocarbon group, or a monovalent halogenated oxygen-containing hydrocarbon group is an alkyl group having 1 to 12 carbon atoms, an alkenyl group having 2 to 12 carbon atoms, an alkynyl group having 2 to 12 carbon atoms, an aryl group having 6 to 18 carbon atoms, a cycloalkyl group having 3 to 18 carbon atoms, an alkoxy group having 1 to 12 carbon atoms, a group in which two or more of the groups are bonded together, a group in which one or more of hydrogen groups in any of the groups are substituted with a halogen group.

(3) The secondary battery according to (1) or (2), in which the unsaturated cyclic ester carbonate is represented by an expression (2) or an expression (3):

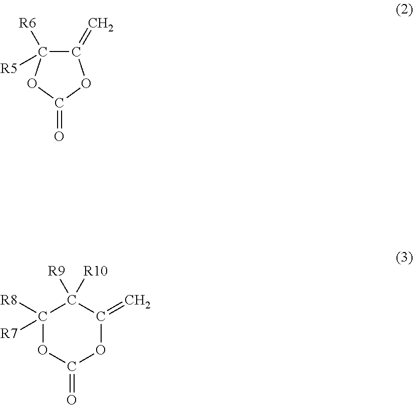

where R5 to R10 each are a hydrogen group, a halogen group, a monovalent hydrocarbon group, a monovalent halogenated hydrocarbon group, a monovalent oxygen-containing hydrocarbon group, or a monovalent halogenated oxygen-containing hydrocarbon group, R5 and R6 may be bonded to each other, and any two or more of R7 to R10 may be bonded to one another.

(4) The secondary battery according to any one of (1) to (3), in which the unsaturated cyclic ester carbonate is represented by any one of expressions (1-1) to (1-56):

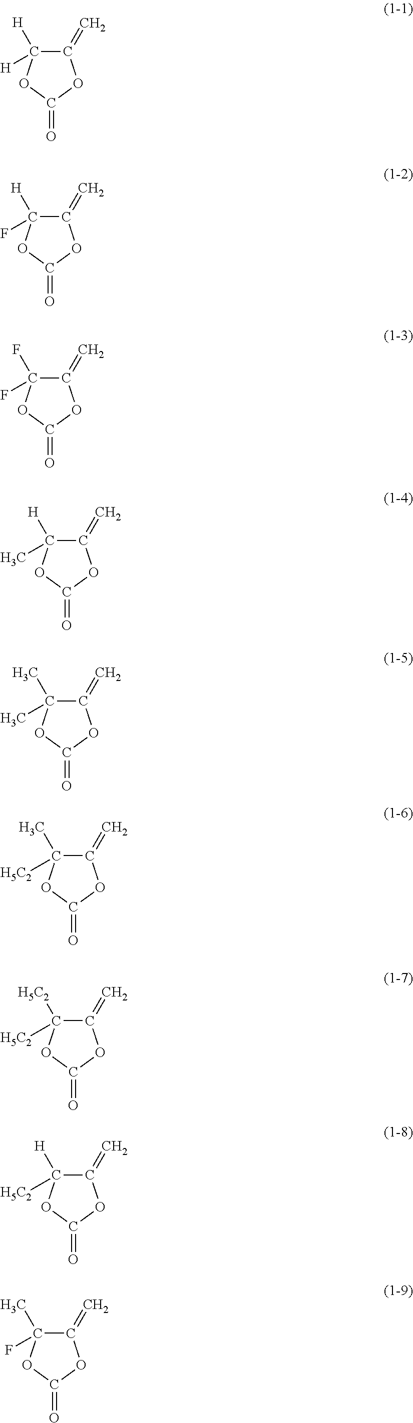

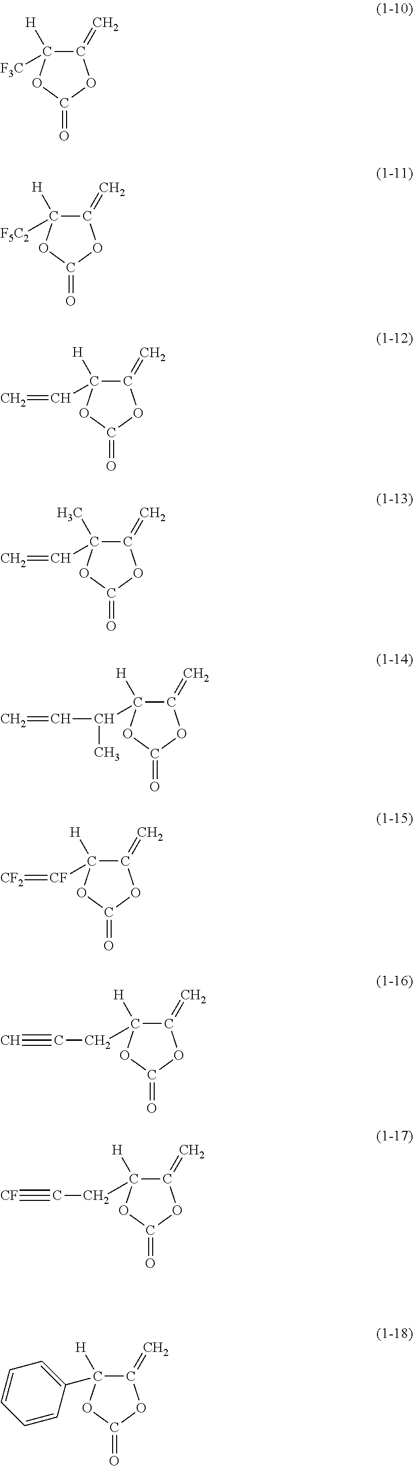

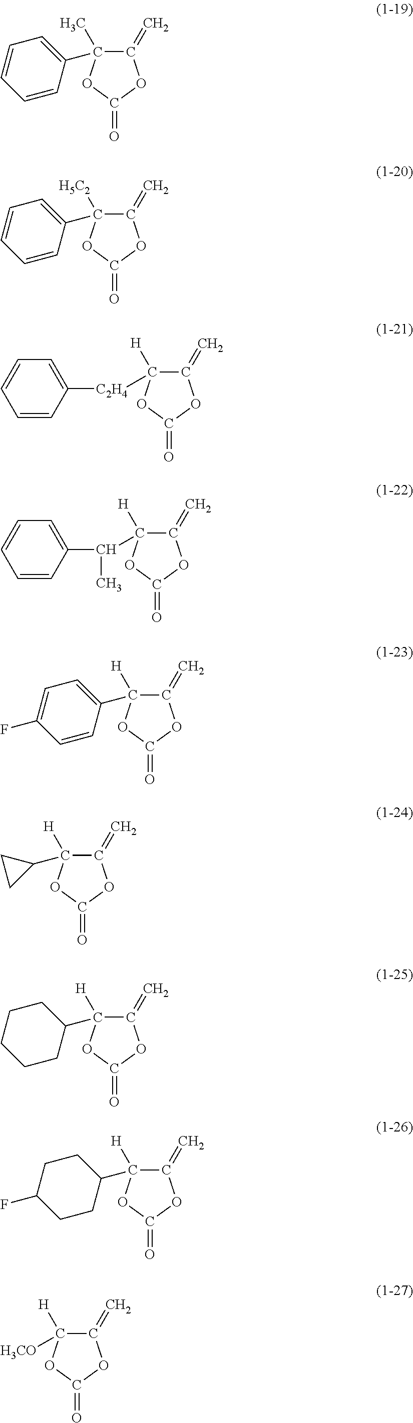

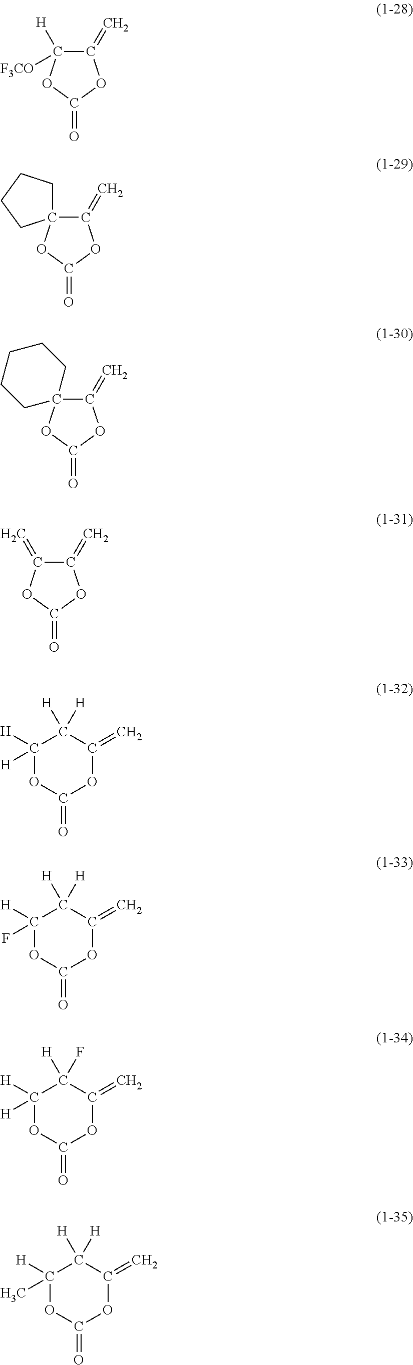

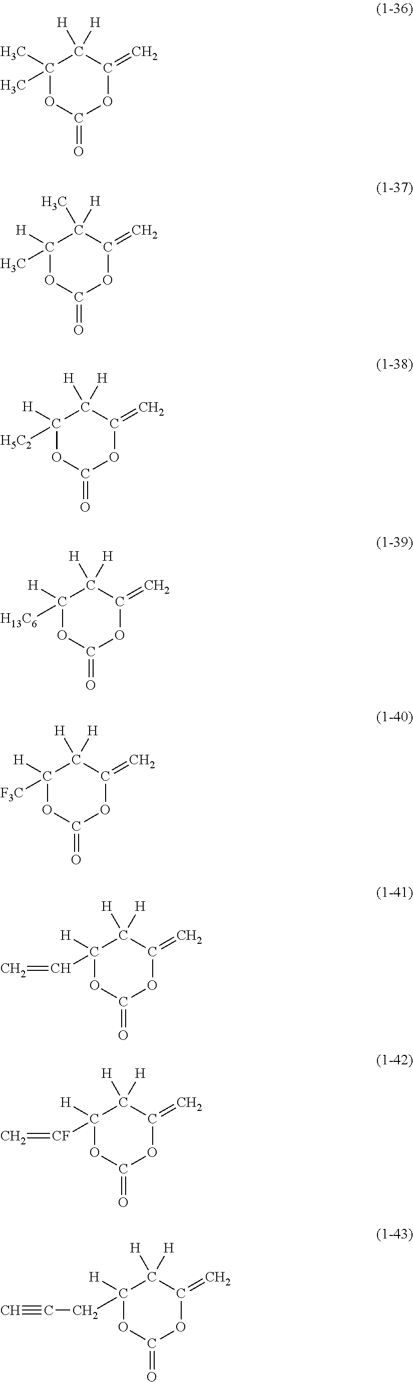

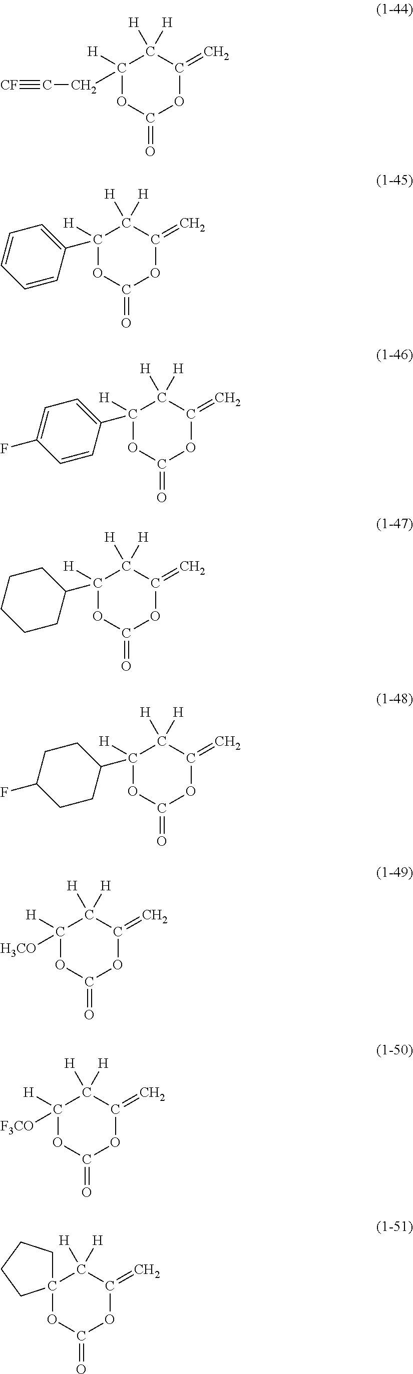

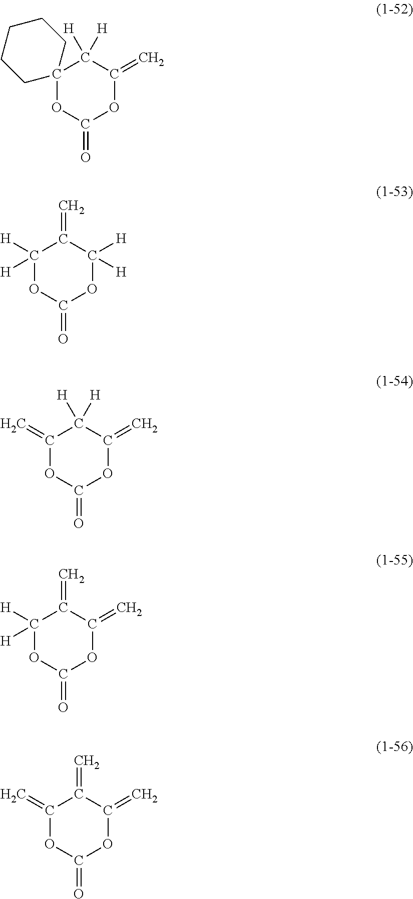

(5) The secondary battery according to any one of (1) to (4), in which a content of the unsaturated cyclic ester carbonate in the electrolytic solution is within a range of about 0.01 wt % to about 10 wt % both inclusive.

(6) The secondary battery according to any one of (1) to (5), in which the cathode includes a compound represented by an expression (21):

Li₁₊ₐMn_{b}Ni_{c}Co_{d}Oₑ (21)

where a to e satisfy 0<a<0.4, 0.4<b<1, 0≦c<0.4, 0≦d<0.4, 1.9<e<2.1, and a+b+c+d=1.

(7) The secondary battery according to any one of (1) to (6), in which

the cathode includes a cathode active material layer, and

the cathode active material layer has a thickness of about 40 μm or over.

(8) The secondary battery according to any one of (1) to (7), in which

the anode includes an anode active material layer, and

the anode active material layer has a thickness of about 20 μm or over.

(9) The secondary battery according to any one of (1) to (8), in which the secondary battery is a lithium-ion secondary battery.

(10) A battery pack including:

the secondary battery according to any one of (1) to (9);

a control section controlling a usage state of the secondary battery; and

a switch section switching the usage state of the secondary battery according to an instruction from the control section.

(11) An electric vehicle including:

the secondary battery according to any one of (1) to (9);

a conversion section converting electric power supplied from the secondary battery into driving force;

a drive section operating according to the driving force; and

a control section controlling a usage state of the secondary battery.

(12) An electric energy storage system including:

the secondary battery according to any one of (1) to (9);

one or two or more electrical units receiving electric power from the secondary battery; and

a control section controlling electric power supply from the secondary battery to the electrical unit.

(13) An electric power tool including:

the secondary battery according to any one of (1) to (9); and

a movable section receiving electric power from the secondary battery.

(14) An electronic unit with the secondary battery according to any one of (1) to (9) as a power supply source.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A secondary battery comprising:
a cathode;
an anode; and
an electrolytic solution,
wherein an open-circuit voltage under a fully-charged state per pair of the cathode and the anode is about 4.3 V or over, and
the electrolytic solution includes an unsaturated cyclic ester carbonate represented by an expression (1): 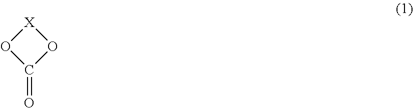
where X is a divalent group in which m-number of >C═CR1R2 and n-number of >CR3R4 are bonded in any order, R1 to R4 each are a hydrogen group, a halogen group, a monovalent hydrocarbon group, a monovalent halogenated hydrocarbon group, a monovalent oxygen-containing hydrocarbon group, or a monovalent halogenated oxygen-containing hydrocarbon group, any two or more of R1 to R4 may be bonded to one another, and m and n satisfy m≧1 and n≧0, respectively.

2. The secondary battery according to claim 1, wherein
the halogen group is a fluorine group, a chlorine group, a bromine group, or a an iodine group, and
the monovalent hydrocarbon group, the monovalent halogenated hydrocarbon group, a monovalent oxygen-containing hydrocarbon group, or a monovalent halogenated oxygen-containing hydrocarbon group is an alkyl group having 1 to 12 carbon atoms, an alkenyl group having 2 to 12 carbon atoms, an alkynyl group having 2 to 12 carbon atoms, an aryl group having 6 to 18 carbon atoms, a cycloalkyl group having 3 to 18 carbon atoms, an alkoxy group having 1 to 12 carbon atoms, a group in which two or more of the groups are bonded together, a group in which one or more of hydrogen groups in any of the groups are substituted with a halogen group.

3. The secondary battery according to claim 1, wherein the unsaturated cyclic ester carbonate is represented by an expression (2) or an expression (3): 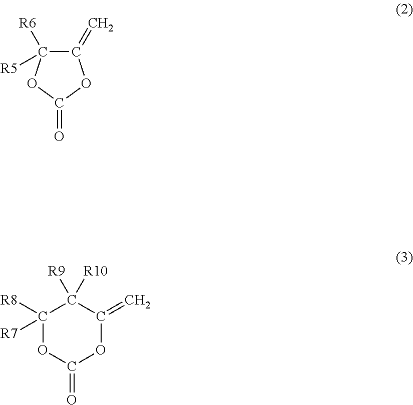
where R5 to R10 each are a hydrogen group, a halogen group, a monovalent hydrocarbon group, a monovalent halogenated hydrocarbon group, a monovalent oxygen-containing hydrocarbon group, or a monovalent halogenated oxygen-containing hydrocarbon group, R5 and R6 may be bonded to each other, and any two or more of R7 to R10 may be bonded to one another.

4. The secondary battery according to claim 1, wherein the unsaturated cyclic ester carbonate is represented by any one of expressions (1-1) to (1-56):

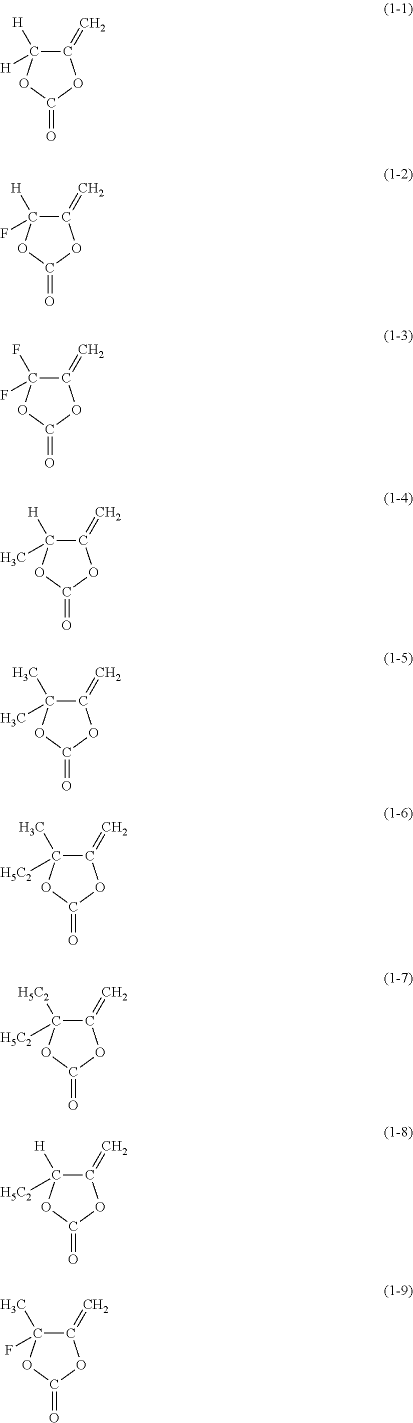

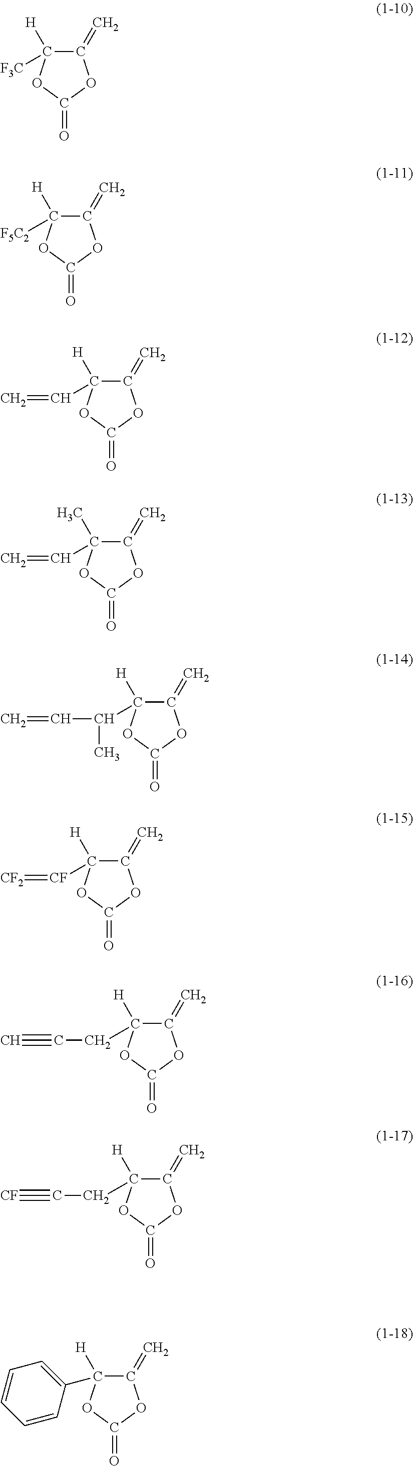

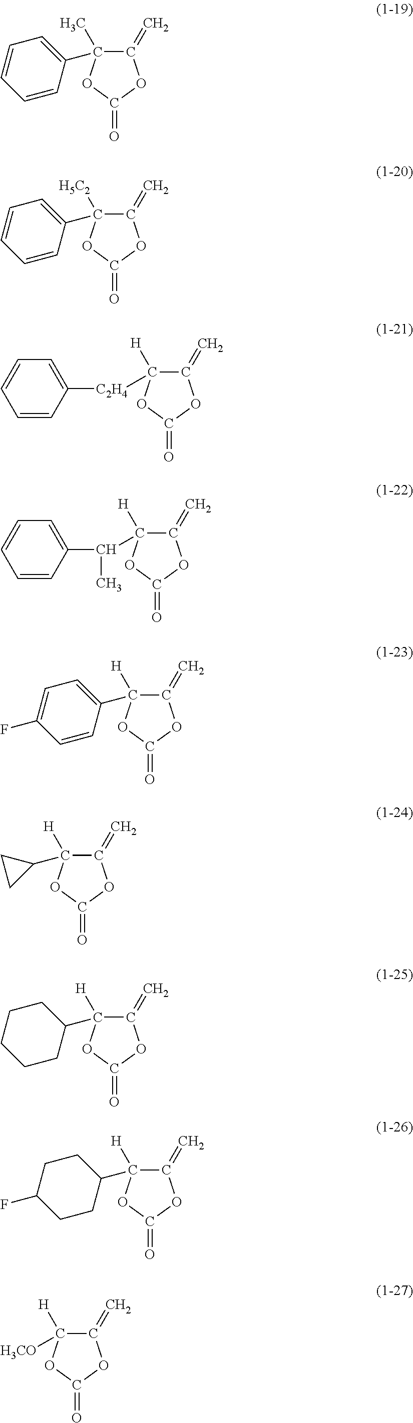

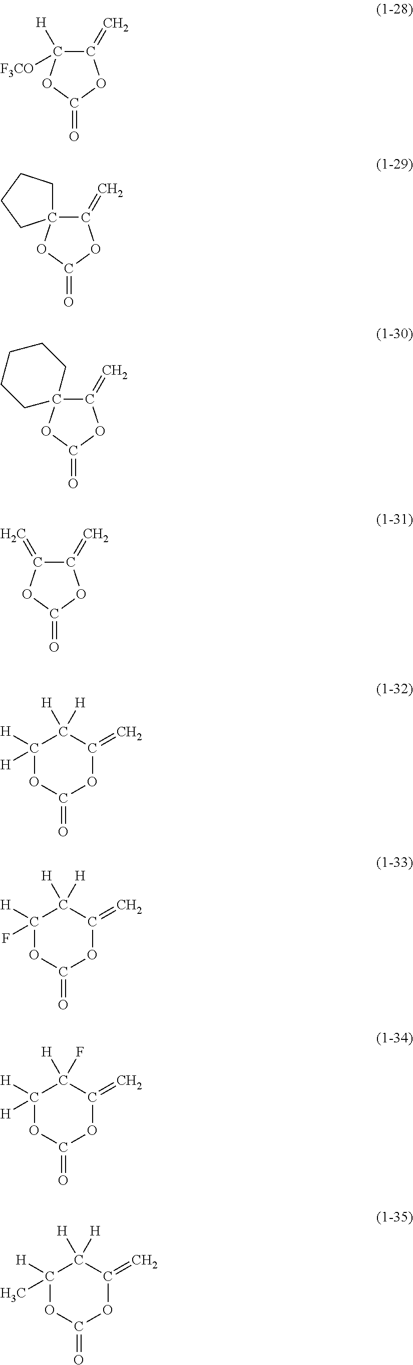

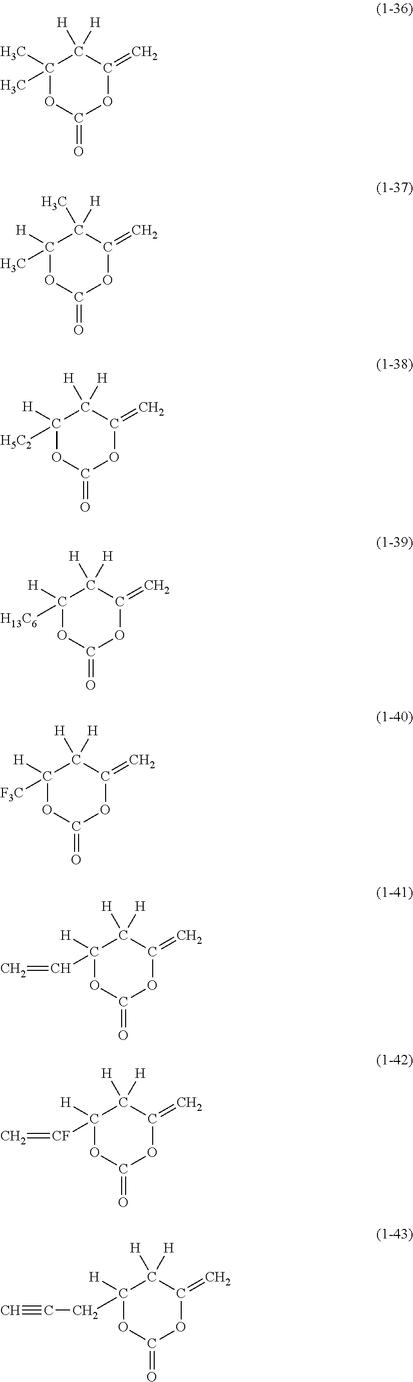

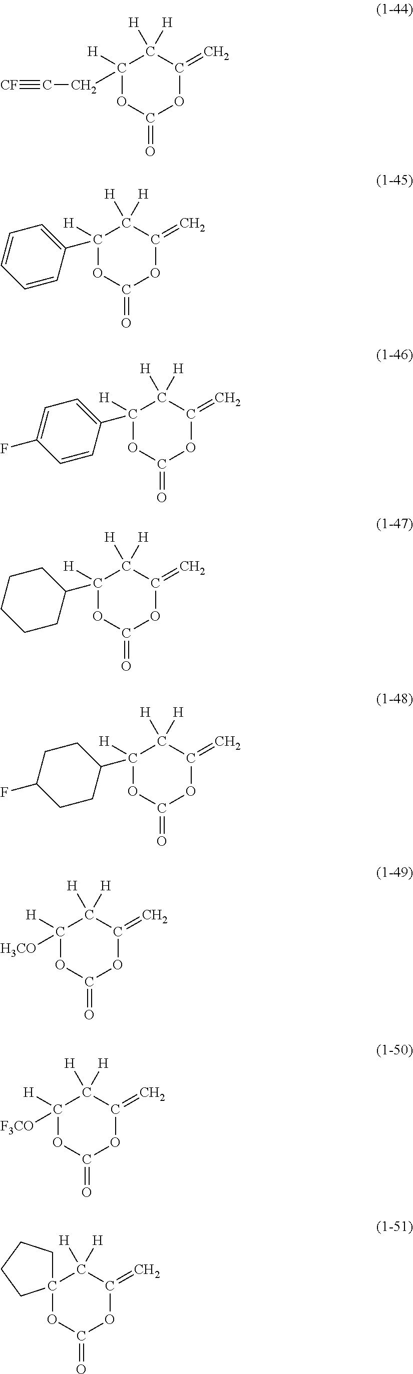

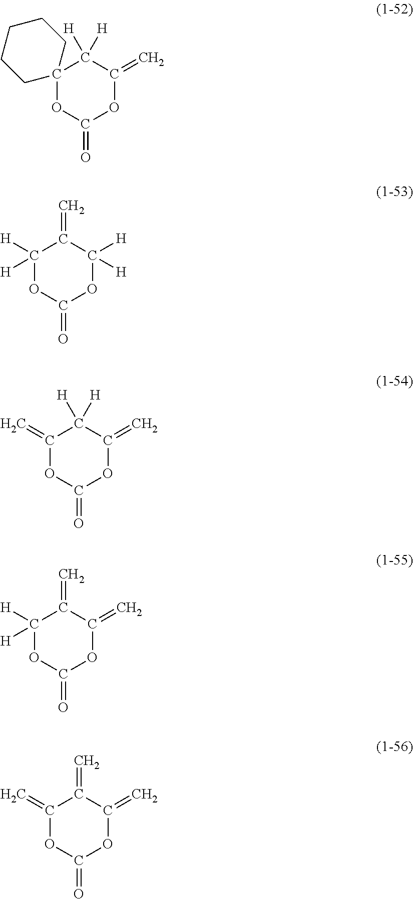

5. The secondary battery according to claim 1, wherein a content of the unsaturated cyclic ester carbonate in the electrolytic solution is within a range of about 0.01 wt % to about 10 wt % both inclusive.

6. The secondary battery according to claim 1, wherein the cathode includes a compound represented by an expression (21):
Li₁₊ₐMn_{b}Ni_{c}Co_{d}Oₑ (21)
where a to e satisfy 0<a<0.4, 0.4<b<1, 0≦c<0.4, 0≦d<0.4, 1.9<e<2.1, and a+b+c+d=1.

7. The secondary battery according to claim 1, wherein
the cathode includes a cathode active material layer, and
the cathode active material layer has a thickness of about 40 μm or over.

8. The secondary battery according to claim 1, wherein
the anode includes an anode active material layer, and
the anode active material layer has a thickness of about 20 μm or over.

9. The secondary battery according to claim 1, wherein the secondary battery is a lithium-ion secondary battery.

10. A battery pack comprising:
a secondary battery;
a control section controlling a usage state of the secondary battery; and
a switch section switching the usage state of the secondary battery according to an instruction from the control section,
wherein the secondary battery includes a cathode, an anode, and an electrolytic solution,
an open-circuit voltage under a fully-charged state per pair of the cathode and the anode is about 4.3 V or over, and
the electrolytic solution includes an unsaturated cyclic ester carbonate represented by an expression (1): 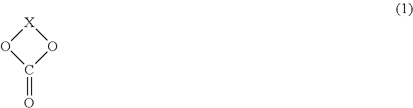
where X is a divalent group in which m-number of >C═CR1R2 and n-number of >CR3R4 are bonded in any order, R1 to R4 each are a hydrogen group, a halogen group, a monovalent hydrocarbon group, a monovalent halogenated hydrocarbon group, a monovalent oxygen-containing hydrocarbon group, or a monovalent halogenated oxygen-containing hydrocarbon group, any two or more of R1 to R4 may be bonded to one another, and m and n satisfy m≧1 and n≧0, respectively.

11. An electric vehicle comprising:
a secondary battery;
a conversion section converting electric power supplied from the secondary battery into driving force;
a drive section operating according to the driving force; and
a control section controlling a usage state of the secondary battery,
wherein the secondary battery includes a cathode, an anode, and an electrolytic solution,
an open-circuit voltage under a fully-charged state per pair of the cathode and the anode is about 4.3 V or over, and
the electrolytic solution includes an unsaturated cyclic ester carbonate represented by an expression (1): 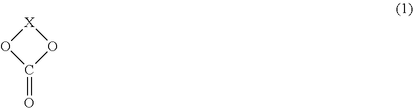
where X is a divalent group in which m-number of >C═CR1R2 and n-number of >CR3R4 are bonded in any order, R1 to R4 each are a hydrogen group, a halogen group, a monovalent hydrocarbon group, a monovalent halogenated hydrocarbon group, a monovalent oxygen-containing hydrocarbon group, or a monovalent halogenated oxygen-containing hydrocarbon group, any two or more of R1 to R4 may be bonded to one another, and m and n satisfy m≧1 and n≧0, respectively.

12. An electric energy storage system comprising:
a secondary battery;
one or two or more electrical units receiving electric power from the secondary battery; and
a control section controlling electric power supply from the secondary battery to the electrical unit,
wherein the secondary battery includes a cathode, an anode, and an electrolytic solution,
an open-circuit voltage under a fully-charged state per pair of the cathode and the anode is about 4.3 V or over, and
the electrolytic solution includes an unsaturated cyclic ester carbonate represented by an expression (1): 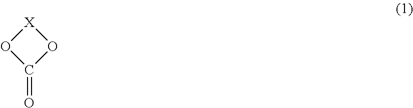
where X is a divalent group in which m-number of >C═CR1R2 and n-number of >CR3R4 are bonded in any order, R1 to R4 each are a hydrogen group, a halogen group, a monovalent hydrocarbon group, a monovalent halogenated hydrocarbon group, a monovalent oxygen-containing hydrocarbon group, or a monovalent halogenated oxygen-containing hydrocarbon group, any two or more of R1 to R4 may be bonded to one another, and m and n satisfy m≧1 and n≧0, respectively.

13. An electric power tool comprising:
a secondary battery; and
a movable section receiving electric power from the secondary battery,
wherein the secondary battery includes a cathode, an anode, and an electrolytic solution,
an open-circuit voltage under a fully-charged state per pair of the cathode and the anode is about 4.3 V or over, and
the electrolytic solution includes an unsaturated cyclic ester carbonate represented by an expression (1): 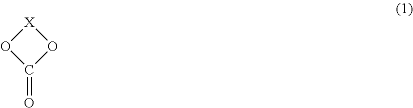
where X is a divalent group in which m-number of >C═CR1R2 and n-number of >CR3R4 are bonded in any order, R1 to R4 each are a hydrogen group, a halogen group, a monovalent hydrocarbon group, a monovalent halogenated hydrocarbon group, a monovalent oxygen-containing hydrocarbon group, or a monovalent halogenated oxygen-containing hydrocarbon group, any two or more of R1 to R4 may be bonded to one another, and m and n satisfy m≧1 and n≧0, respectively.

14. An electronic unit with a secondary battery as a power supply source, the secondary battery comprising:
a cathode;
an anode; and
an electrolytic solution,
wherein an open-circuit voltage under a fully-charged state per pair of the cathode and the anode is about 4.3 V or over, and
the electrolytic solution includes an unsaturated cyclic ester carbonate represented by an expression (1): 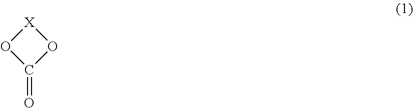
where X is a divalent group in which m-number of >C═CR1R2 and n-number of >CR3R4 are bonded in any order, R1 to R4 each are a hydrogen group, a halogen group, a monovalent hydrocarbon group, a monovalent halogenated hydrocarbon group, a monovalent oxygen-containing hydrocarbon group, or a monovalent halogenated oxygen-containing hydrocarbon group, any two or more of R1 to R4 may be bonded to one another, and m and n satisfy m≧1 and n≧0, respectively.
